(19) United States
(12) Patent Application Publication
(10) Pub. No.: US 2026/0029503 A1
(43) Pub. Date: Jan. 29, 2026

(54) SYSTEMS AND METHODS FOR MICRO-POSITIONING IN A GAMING ENVIRONMENT USING A WIRELESS LOW-POWER PERSONAL AREA NETWORK

(71) Applicant: JCM American Corporation, Las Vegas, NV (US)

(72) Inventors: Kwun Lai, Las Vegas, NV (US); Mike Nguyen, Las Vegas, NV (US); David C. Kubajak, Las Vegas, NV (US); Aaron Sargento, Las Vegas, NV (US); Jordan Cagle, Las Vegas, NV (US)

(21) Appl. No.: 18/781,929

(22) Filed: Jul. 23, 2024

(51) Int. Cl. G01S 5/02; G01S 5/14; G06Q 30/015; G06Q 50/34; G07F 17/32

(52) U.S. Cl. CPC G01S 5/02213; G01S 5/14; G06Q 30/015; G06Q 50/34; G07F 17/3223; G01S 2205/09

(57) ABSTRACT

Systems and methods utilizing micro-positioning. The systems and methods detailed herein involve various configurations of components, including using one or more of BLE beacons, BLE tags, mobile I/O, Peripheral Network Adapters (PNA) with mobile I/O, mobile devices and electronic gaming machines (EGM). One or more casino and/or 3^{rd} party network systems may also be utilized to facilitate and utilize the tracking abilities of the systems and methods. The systems and methods allow patrons to be tracked in a space, (e.g., casino floor) and sent promotions based on their location. The system and methods may also be used by the casino to: track player EGM usage, direct slot technicians to EGMs requiring attention, fulfill service requests, direct casino personnel to EGMs requiring cashboxes to be emptied, generate casino floor maps, allow patrons to redeem tickets, cash in chips and pay bills, etc.

### FIELD OF THE INVENTION

The embodiments of the present invention relate to systems and methods for determining real-time indoor positioning utilizing, in one embodiment, Bluetooth Low Energy (BLE).

### BACKGROUND

As gaming has proliferated, casinos have become larger and larger. Many casinos have gaming floors in excess of 100,000 ft² with hundreds or thousands of table games and electronic gaming machines. Quickly and accurately tracking the position of patrons within casinos provides many benefits to the casinos. Casinos may use player locations to target player promotions and advertisements, service player requests, send players location-specific notifications, understand player locations relative to table games and electronic gaming machines, etc. Such a system may further provide casinos casino floor management and casino operations data and feedback.

It would be advantageous for the casino and players to utilize systems and methods for tracking, in real-time, player positions in a casino environment. It would be further beneficial if the systems and methods utilized BLE to reduce power consumption and costs.

### SUMMARY

The embodiments disclosed herein involve various configurations of components, including a peripheral system including peripheral network adapters installed in electronic gaming machines and BLE beacons positioned about a casino floor and optionally neighboring areas.

The embodiments described herein generally reference methods and systems for tracking patrons, casino personnel and casino assets on a casino floor.

In one embodiment, via mobile devices (e.g., smart phones), the casino can provide services and/or directions to the casino patrons, which allow casino patrons to enjoy an enhanced experience through their mobile device while at the casino.

In another embodiment described herein generally reference methods and systems for tracking patrons and casino personnel on a casino floor. Via mobile devices (e.g., smart phones), the casino can then send notifications to a mobile device, where the end user is expected to be a patron, slot technician, etc.

In another embodiment, patron tracking provides means for determining players' interactions with EGMs related to cash-in and cash-out involving detecting a patron's proximity to a specific EGM.

In another embodiment, the tracking system detailed herein provides data permitting casino floor management such as mapping and asset cashbox management.

Embodiments described herein generally reference methods and systems of tracking casino patrons in a casino environment by using one or more of BLE beacons, BLE tags, mobile I/Os, Peripheral Network Adapters (PNA), mobile devices and electronic gaming machines (EGM). One or more casino and/or 3^{rd} party network systems may also be utilized to facilitate and utilize the tracking abilities of the embodiments of the present invention.

Other variations, embodiments and features of the present invention will become evident from the following detailed description, drawings and claims.

### BRIEF DESCRIPTION OF THE DRAWINGS

The disclosure will be readily understood by the following detailed description in conjunction with the accompanying drawings, wherein like reference numerals designate like structural elements.

FIG. 1 is a block diagram of a casino system according to the embodiments of the present invention.

FIG. 2 is a block diagram illustrating installing and registering Peripheral Network Adapters (PNA) according to the embodiments of the present invention;

FIG. 3 is a block diagram illustrating installing and registering Bluetooth Low Energy (BLE) beacons according to the embodiments of the present invention;

FIG. 4 is a block diagram illustrating collecting information from PNAs for approximation from a specific PNA according to the embodiments of the present invention;

FIG. 5 is a block diagram illustrating collecting information from beacons for approximation from a specific PNA according to the embodiments of the present invention;

FIG. 6 is a block diagram illustrating using both PNAs and BLE beacons for micro-positioning according to the embodiments of the present invention;

FIG. 7 is a block diagram illustrating a map finalizing process according to the embodiments of the present invention;

FIG. 8 is a block diagram of possible interconnections of components according to the embodiments of the present invention;

FIG. 9 is a block diagram illustrating an arrangement of components to approximate the distance from a BLE tag to a PNA according to the embodiments of the present invention;

FIG. 10 is a block diagram illustrating an arrangement of components to approximate the distance from a BLE tag to a mobile device according to the embodiments of the present invention;

FIG. 11 is a block diagram illustrating an arrangement of components to approximate the distance from a PNA to a BLE beacon according to the embodiments of the present invention;

FIG. 12 is a block diagram illustrating an arrangement of components to approximate the distance from a PNA to another PNA according to the embodiments of the present invention;

FIG. 13 is a block diagram illustrating an arrangement of components to approximate the distance from a PNA to a mobile device according to the embodiments of the present invention;

FIG. 14 is a block diagram illustrating an arrangement of components to approximate the distance from a mobile device to a BLE beacon according to the embodiments of the present invention;

FIG. 15 is a block diagram illustrating an arrangement of components to approximate the distance from a mobile device to a PNA according to the embodiments of the present invention;

FIG. 16 is a block diagram illustrating an arrangement of components to approximate the distance from a mobile device to another mobile device according to the embodiments of the present invention;

FIG. 17 is a block diagram illustrating an arrangement of components to approximate the location of a BLE tag based on multiple PNAs reporting the BLE tag according to the embodiments of the present invention;

FIG. 18 is a block diagram illustrating an arrangement of components to approximate the location of a BLE tag based on multiple mobile devices reporting the BLE tag according to the embodiments of the present invention;

FIG. 19 is a block diagram illustrating a first arrangement of components to approximate the location of a PNA according to the embodiments of the present invention;

FIG. 20 is a block diagram illustrating a second arrangement of components to approximate the location of a PNA according to the embodiments of the present invention;

FIG. 21 is a block diagram illustrating a third arrangement of components to approximate the location of a PNA according to the embodiments of the present invention;

FIG. 22 is a block diagram illustrating a fourth arrangement of components to approximate the location of a PNA according to the embodiments of the present invention;

FIG. 23 is a block diagram illustrating a fifth arrangement of components to approximate the location of a PNA according to the embodiments of the present invention;

FIG. 24 is a block diagram illustrating a first arrangement of components to approximate the location of a mobile device according to the embodiments of the present invention;

FIG. 25 is a block diagram illustrating a second arrangement of components to approximate the location of a mobile device according to the embodiments of the present invention;

FIG. 26 is a block diagram illustrating a third arrangement of components to approximate the location of a mobile device according to the embodiments of the present invention;

FIG. 27 is a block diagram illustrating a fourth arrangement of components to approximate the location of a mobile device according to the embodiments of the present invention;

FIG. 28 is a block diagram illustrating a fifth arrangement of components to approximate the location of a mobile device according to the embodiments of the present invention;

FIG. 29 is a block diagram illustrating a first arrangement of components whereby a patron may request services according to the embodiments of the present invention;

FIG. 30 is a block diagram illustrating a second arrangement of components whereby a patron may request services according to the embodiments of the present invention;

FIG. 31 illustrates a block diagram of a first arrangement of components whereby the system may notify a patron according to the embodiments of the present invention;

FIG. 32 illustrates a block diagram of a second arrangement of components whereby the system may notify a patron according to the embodiments of the present invention;

FIG. 33 illustrates a block diagram of an arrangement of components whereby the system may handle a forgotten or lost ticket according to the embodiments of the present invention;

FIG. 34 illustrates a block diagram of a first arrangement of components whereby the system may track the location of a patron's smart device according to the embodiments of the present invention;

FIG. 35 illustrates a block diagram of a second arrangement of components whereby the system may track the location of a patron's smart device according to the embodiments of the present invention;

FIG. 36 illustrates a block diagram of a first arrangement of components whereby the system may track EGM usage according to the embodiments of the present invention;

FIG. 37 illustrates a block diagram of a second arrangement of components whereby the system may track EGM usage according to the embodiments of the present invention;

FIG. 38 illustrates a block diagram of a third arrangement of components whereby the system may track EGM usage according to the embodiments of the present invention;

FIG. 39 illustrates a block diagram of a first arrangement of components whereby the system may provide directions to a patron according to the embodiments of the present invention;

FIG. 40 illustrates a block diagram of a second arrangement of components whereby the system may provide directions to a patron according to the embodiments of the present invention;

FIG. 41 illustrates a block diagram of an arrangement of components whereby the system may provide foot traffic information to a user according to the embodiments of the present invention;

FIG. 42 illustrates a block diagram of a first arrangement of components whereby the system may send notification to a patron according to the embodiments of the present invention;

FIG. 43 illustrates a block diagram of a second arrangement of components whereby the system may send notification to a patron according to the embodiments of the present invention;

FIG. 44 illustrates a block diagram of a third arrangement of components whereby the system may send notification to a patron according to the embodiments of the present invention;

FIG. 45 illustrates a block diagram of a fourth arrangement of components whereby the system may send notification to a patron according to the embodiments of the present invention;

FIG. 46 illustrates a block diagram of a first arrangement of components whereby the system may send notification to casino personnel according to the embodiments of the present invention;

FIG. 47 illustrates a block diagram of a second arrangement of components whereby the system may send notification to casino personnel according to the embodiments of the present invention;

FIG. 48 illustrates a block diagram of a third arrangement of components whereby the system may send notification to casino personnel according to the embodiments of the present invention;

FIG. 49 illustrates a block diagram of a fourth arrangement of components whereby the system may send notification to casino personnel according to the embodiments of the present invention;

FIG. 50 illustrates a block diagram of a first arrangement of components whereby the system may send promotions to a patron according to the embodiments of the present invention;

FIG. 51 illustrates a block diagram of a second arrangement of components whereby the system may send promotions to a patron according to the embodiments of the present invention;

FIG. 52 illustrates a block diagram of a third arrangement of components whereby the system may send promotions to a patron according to the embodiments of the present invention;

FIG. 53 illustrates a block diagram of a fourth arrangement of components whereby the system may send promotions to a patron according to the embodiments of the present invention;

FIG. 54 illustrates a block diagram of a first arrangement of components whereby the system may send promotions to a patron based on EGM play according to the embodiments of the present invention;

FIG. 55 illustrates a block diagram of a second arrangement of components whereby the system may send promotions to a patron based on EGM play according to the embodiments of the present invention;

FIG. 56 illustrates a block diagram of a third arrangement of components whereby the system may send promotions to a patron based on EGM play according to the embodiments of the present invention;

FIG. 57 illustrates a block diagram of a fourth arrangement of components whereby the system may send promotions to a patron based on EGM play according to the embodiments of the present invention;

FIG. 58 illustrates a block diagram of a first arrangement of components whereby the system may send promotions to a patron during EGM play according to the embodiments of the present invention;

FIG. 59 illustrates a block diagram of a second arrangement of components whereby the system may send promotions to a patron during EGM play according to the embodiments of the present invention;

FIG. 60 illustrates a block diagram of a third arrangement of components whereby the system may send promotions to a patron during EGM play according to the embodiments of the present invention;

FIG. 61 illustrates a block diagram of a fourth arrangement of components whereby the system may send promotions to a patron during EGM play according to the embodiments of the present invention;

FIG. 62 illustrates a block diagram of a first arrangement of components whereby the system may send gameplay notifications to the casino according to the embodiments of the present invention;

FIG. 63 illustrates a block diagram of a second arrangement of components whereby the system may send gameplay notifications to the casino according to the embodiments of the present invention;

FIG. 64 illustrates a block diagram of a third arrangement of components whereby the system may send gameplay notifications to the casino according to the embodiments of the present invention;

FIG. 65 illustrates a block diagram of a fourth arrangement of components whereby the system may send gameplay notifications to the casino according to the embodiments of the present invention;

FIG. 66 illustrates a block diagram of a first arrangement of components whereby the system may automate EGM actions according to the embodiments of the present invention;

FIG. 67 illustrates a block diagram of a second arrangement of components whereby the system may automate EGM actions according to the embodiments of the present invention;

FIG. 68 illustrates a block diagram of a third arrangement of components whereby the system may automate EGM actions according to the embodiments of the present invention;

FIG. 69 illustrates a block diagram of a fourth arrangement of components whereby the system may automate EGM actions according to the embodiments of the present invention;

FIG. 70 illustrates a block of a fifth arrangement of components whereby the system may automate EGM actions according to the embodiments of the present invention;

FIG. 71 illustrates a flow chart detailing an asset mapping according to the embodiments of the present invention;

FIG. 72 illustrates an exemplary casino floor map generated according to the embodiments of the present invention;

FIG. 73 illustrates another exemplary casino floor map generated with data feedback according to the embodiments of the present invention;

FIG. 74 illustrates another exemplary casino floor map generated with data feedback according to the embodiments of the present invention;

FIG. 75 illustrates another exemplary casino floor map generated with data feedback according to the embodiments of the present invention;

FIG. 76 illustrates another exemplary casino floor map generated with data feedback according to the embodiments of the present invention;

FIG. 77 illustrates a block diagram of an arrangement of components whereby the system may facilitate a cash out to a player wallet according to the embodiments of the present invention;

FIG. 78 illustrates a block diagram of an arrangement of components whereby the system may redeem player chips to a player wallet according to the embodiments of the present invention;

FIG. 79 illustrates a block diagram of another arrangement of components whereby the system may redeem player chips to a player wallet according to the embodiments of the present invention; and

FIG. 80 illustrates a block diagram of another arrangement of components whereby the system may redeem coupons according to the embodiments of the present invention.

Additionally, it should be understood that the proportions and dimensions (either relative or absolute) of the various features and elements (and collections and groupings thereof) and the boundaries, separations, and positional relationships presented therebetween, are provided in the accompanying Figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wired, wireless, wireline, optical fiber cable, RF, Bluetooth and the like, or any suitable combination of the foregoing. Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming machine” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

Those skilled in the art will recognize that certain types of EGMs, generally utilized in regulated casino environments, are still commonly referred to as “slot machines”. Although the etymology of the term “slot machine” was originally derived from a coin slot in the gaming machines at the time, coin slots have long since generally been replaced by payment input devices or bill validators which only accept paper currency or ticket-in-ticket-out vouchers and/or electronic fund transfer means, such as card readers, mobile device payment means or account interfaces. As a result, the term EGM and slot machine are used interchangeably and are defined to mean something different than a laptop or desktop computer, cell phones, tablet computer gaming devices and the like.

The embodiments described herein are generally, but not necessarily exclusively, directed to systems, devices, and methods to track patrons and casino personnel within a casino environment. Tracking patrons and personnel utilizes personal mobile electronic devices held, worn or otherwise on the patron or personnel.

Examples of user personal mobile electronic devices include cell phones, personal digital assistants (PDA), tablet or laptop computers, smart cards, smart watches, smart key chains, devices with an implantable smart chip, and the like. Hereinafter, such personal mobile electronic devices will be referred to as “mobile devices.” More specific details on such devices and their operations are described in greater detail below.

Examples of the various systems, devices, and equipment operated by a casino in conjunction with an electronic gaming device include bank note or bill acceptor/validators (or “bill validators”), gaming ticket receivers/printers, kiosks at which a user may obtain gaming credit (hereinafter, “credit”) or funds for wagering, routers, and antennas to provide wireless communications (such as Wi-Fi®, Bluetooth, radio frequency identification technologies, near field communication technologies, or other technologies), internet connection servers and systems, casino accounting services, and other systems and equipment. Such systems, devices, and equipment may be based in hardware or software. Such systems, devices, and equipment may be implemented, either in hardware or software, to provide secure transactions with the mobile device. Specific devices, methods, and systems operated by the casino are described in greater detail below.

The systems, methods, and devices described herein make use of a set of similar—but not necessarily identical—components. As used herein, the term “system” can also be used to refer to subsystems that may be used within other systems. As used herein, “component” will refer to a system, whether implemented in hardware or software, a subsystem, a device performing a certain operation, or a method of operation. Operations performed by the systems, methods, and devices may be performed using one or more processing units.

As used herein, a “processing unit” will refer to any of a processor, microprocessor, microcontroller, application specific integrated circuit and related circuitry, or other operational elements as would be known to one skilled in the art. Also encompassed by the term “component” are digital and analog communication elements, circuits, or devices, such as may be operable to send and/or receive signals or messages over a variety of communication channels. Such channels include, but are not limited to, fiber optic links, coax or twisted pair cable, other forms of wired connections, wireless connections such as Bluetooth, Wi-Fi®, cellular communication networks, various near field communication links, and the like.

Described below are certain components to be used in subsequent block diagrams of the systems, methods, and devices that may be used in various embodiments disclosed herein. It is not implied that all such components are included in each embodiment, nor that the embodiments are limited to these components or devices. Less commonly used components may be described in relation to particular subsequent Figures. Similarly named components in the Figures may be similar in structure and/or operation, but may have differences; it is not implied they are identical devices.

A first such component is a user's mobile device. A mobile device may be a mobile phone, a smart card, a smart watch, a laptop or tablet computer, a smart key chain, a personal digital assistant, or another user device. The mobile device may include any of various electromagnetic communication technologies. These electromagnetic communication technologies include, but are not limited to, Bluetooth or Bluetooth Low Energy, infrared or other optical technologies, Wi-Fi®, NFC bump, cellular technologies including, but not limited to CDMA, EDGE, 2G, 3G, 4G, 4G-LTE, or 5G, or other electromagnetic communication technologies. A mobile device may also be able to display a code (e.g., bar code, alphanumeric code, QR code, or other code format) that the user may then manually enter into another device or component.

Another such component may be a Peripheral System. A Peripheral System is a service or system that may work with or within a casino network (such as the casino management system (CMS) described below). The Peripheral System may assist and/or interface between various peripheral components of a CMS, such as the components described herein.

Another such component may be the Peripheral Network Adapter (PNA). The PNA may connect to one or more peripheral components and a network (e.g., CMS) allowing those peripherals to be part of the system and enable certain operations. Such components include the components described herein. Alternatively, the PNA may be a component within any of the components described herein. The PNA can be two separate devices, such as a Wireless Interface and a PNA or a single device that integrates the functionality of both the wireless interface and the PNA. While the PNA may be its own device, it may also be part of another component such as a bill validator, ticket printer, player interface device, etc.

Another such component may be the Player Interface Device. A Player Interface Device will refer herein to any device connected with an electronic gaming machine (EGM) or casino table game system or individual table game with which a user may interact, such as with a mobile device. A Player Interface Device can refer to, among other devices, a bill validator, a bill validator having a bezel containing communication technologies (NFC, optical code readers, or other technologies), a TITO System, a card (credit card, debit card, specialty card, etc.) reader, or another type of component.

Another such component may be a Casino Management System (CMS). A CMS may be a network service or system used within a casino to link some or all of the components listed above.

Other components may be described in the descriptions of the following Figures.

Applicant incorporates by reference for all purposes co-pending U.S. Pat. Nos. 10,140,817, 10,621,825, 10,643,194 and 10,970,967 owned by Applicant or sister company and which detail Applicant's system known as FUZION.

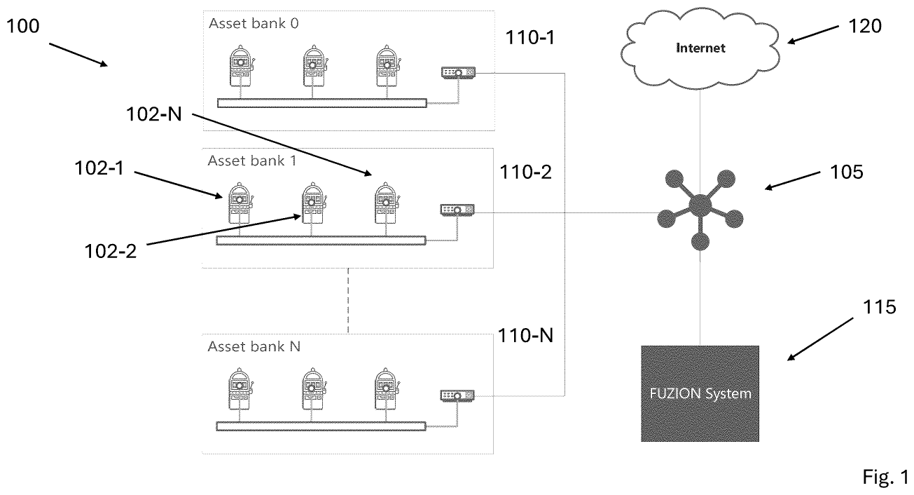

FIG. 1 shows a network 100 of multiple EGM banks 110-1 through 110-N connecting to a casino network 105 with access to a peripheral system (FUZION) 115. The peripheral system 115 is configured to compute data for the system. The casino network 105 is also connected to the internet 120. In a typical casino environment, the EGMs 102-1 through 102-N are grouped together in EGM banks 110-1 through 110-N. The typical number of EGMs 102-1 through 102-N forming a bank are approximately between 4 and 8 or more depending on a casino's configuration. A peripheral network adapter (PNA) and mobile I/O is installed within each EGM 102-1 through 102-N. The PNA controls the Mobile I/O to act as both a scanner and receiver. The PNA is connected to the casino network 105 to report to the peripheral system 115. Each bank of EGMs 110-1 through 110-N connect to the peripheral system 115 through the casino network 105 via an ethernet connection on a peripheral network adapter (PNA).

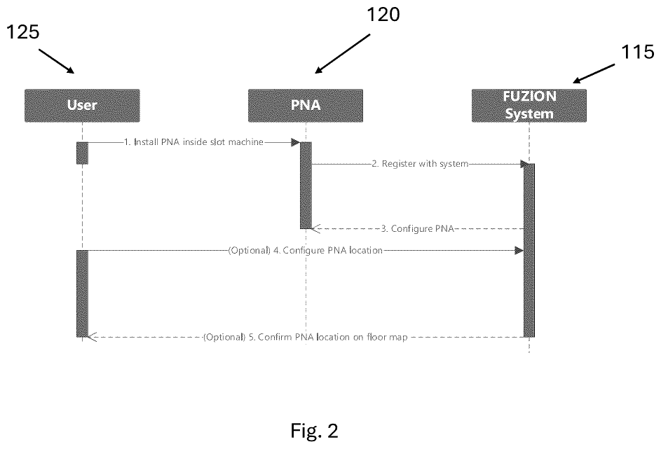

FIG. 2 shows a block diagram illustrating installing and registering PNAs according to the embodiments of the present invention. Each PNA 120 connects to the peripheral system 115 via the casino network 105. In one embodiment, the operator physically installs a PNA 120 inside each EGM. The PNA 120 is configured to automatically register with the peripheral system 115. The process comprises: (i) PNA 120 is installed in each EGM; (ii) PNA 120 is powered on and automatically registers with the peripheral system 115; (iii) the peripheral system 115 configures the PNA 120; (iv) operator may manually configure the placement of the PNAs 120 on a casino floor map and (v) the peripheral system 115 confirms the location of the PNA 120 with the operator.

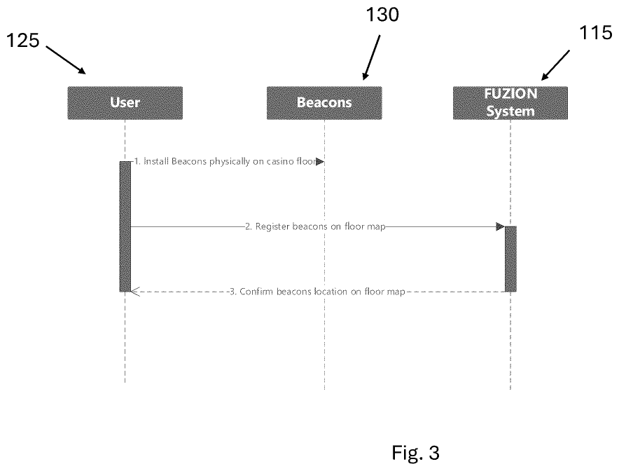

FIG. 3 shows a block diagram illustrating installing and registering Bluetooth Low Energy (BLE) beacons 130 according to the embodiments of the present invention. BLE beacons 130 passively broadcast their ID information to any device configured to read it. The BLE beacons 130 broadcast their ID information to allow the PNA 120 to calculate distance to the BLE beacons 130. The peripheral system 115 can then use the distance information calculated by the PNAs to approximate the location of the EGMs. In one embodiment, the BLE beacons 130 are not connected to any backend system. Each BLE beacon 130 is configured and registered by the operator on the peripheral system 115. The process comprises: (i) each BLE beacon 130 is installed at a stationary position on a casino floor by the operator; (ii) once installed, the operator registers the BLE beacons 130 on the peripheral system 115; and (iii) the peripheral system 115 confirms placement/location of the BLE beacons 130.

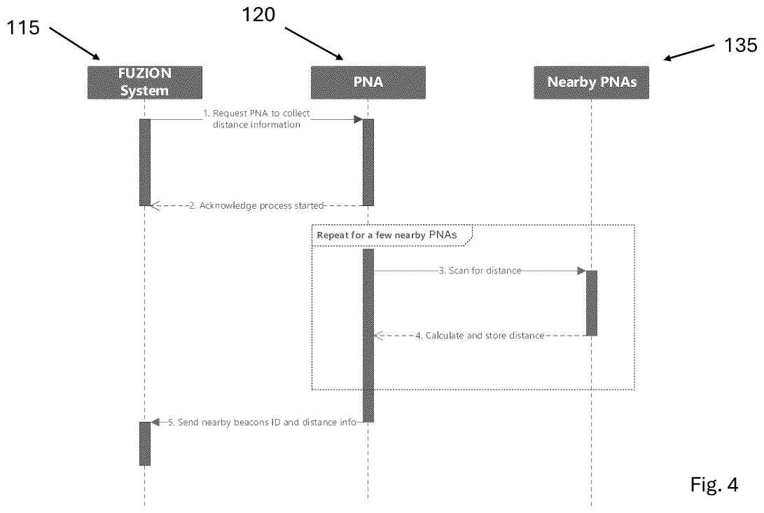

FIG. 4 shows a block diagram illustrating collecting information from PNAs 135 for approximation from a specific PNA 120 according to the embodiments of the present invention. To provide a visual mapping of the EGMs to the operator, the peripheral system 115 utilizes a floor map in the form of an image or drawing. The floor map provides a visualization of the EGM locations for the operator. The peripheral system 115 utilizes the floor map to compute accurate positions. The peripheral system 115 allows several different ways to create a floor map including uploading floor map image thereto or manually creating a floor map. The peripheral system 115 approximates EGM location on the floor map based on location of a plurality of EGMs and BLE beacons 130.

Due to the number of EGMs on the casino floor, it is not ideal for a user to manually configure each EGM on a floor map. The operator is thus only required to configure a few EGMs in key locations on the floor map. The initial EGMs can then be used by the peripheral system 115 to approximate and generate the location of the other EGMs. In the setup of FIG. 4, each of the PNAs 120 serve as fixed location beacons for one another. As detailed above, each of the PNAs 135 is installed within an EGM and registered with the peripheral system 115. Once ready, the peripheral system 115 requests a target PNA 120 to probe information and calculate distance to a few nearby PNAs 135. Using the information, the peripheral system 115 calculates the position of the PNAs 135 relative to one another.

As shown in FIG. 4, the process comprises: (i) the peripheral system 115 requesting a specific PNA 120 to collect distance information from nearly PNAs 135; (ii) the targeted PNA 120 acknowledges and begins the process; (iii) the targeted PNA 120 scans nearby several PNAs 135 for information needed for distance calculation; and (iv) the targeted PNA 120 sends the information collected from PNAs 135 and calculated distances to the peripheral system 115.

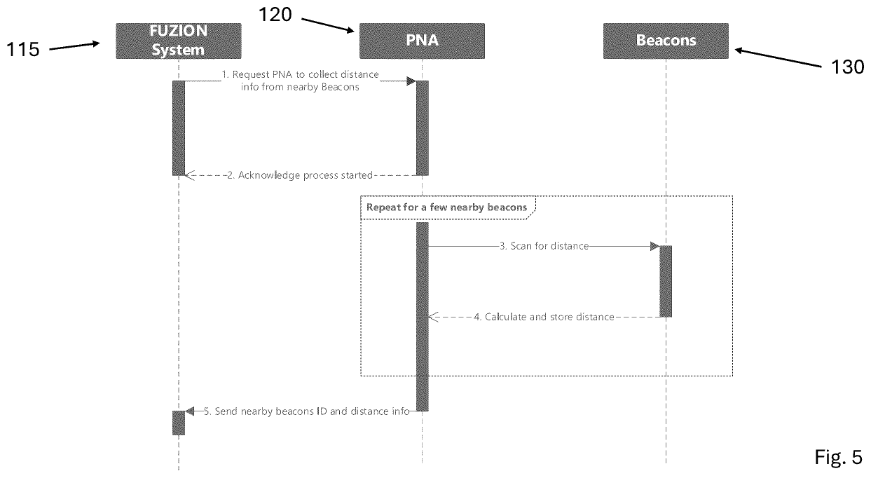

FIG. 5 shows a block diagram illustrating collecting information from BLE beacons 130 for approximation from a specific PNA 120 according to the embodiments of the present invention. In this process, stationary BLE beacons 130 have been installed around the casino floor in places such as pillars, doorways, and/or cabinets. Each of the BLE beacons 130 are already registered and placed on a floor map. These stationary BLE beacons 130 allow PNAs 135 to probe for the IDs and calculate distances upon request by the peripheral system 115. Using the information, the peripheral system 115 approximates the position of the PNAs 135 relative to the BLE beacons 130. The process comprises (i) the peripheral system 115 requests the PNA 120 to start collecting distance information from nearby PNAs 135; (ii) the PNA 120 acknowledges and begins the process; (iii) the PNA 120 scans nearby BLE beacons 130 for information needed for distance calculation; (iv) the PNA 120 calculates distance and stores the nearby BLE beacon 130 information; and (v) the PNA 120 sends the list of PNA information and distances to the peripheral system 115.

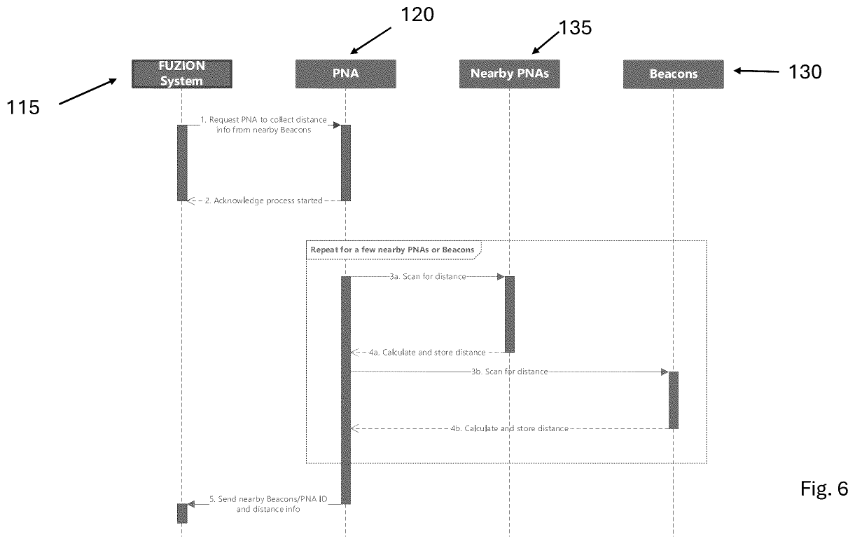

FIG. 6 shows a block diagram illustrating using both PNAs and BLE beacons for micro-positioning according to the embodiments of the present invention. The process comprises (i) the peripheral system 115 requests the PNA 120 to start collecting distance information from nearby PNAs 135 and BLE beacons 130; (ii) the PNA 120 acknowledges and begins the process; (iii) the PNA 120 scans nearby PNAs 135 and BLE beacons 130 for information needed for distance calculation; (iv) the PNA 120 calculates distance and stores the information; and (v) the PNA 120 sends the list of components information and distances to the peripheral system 115.

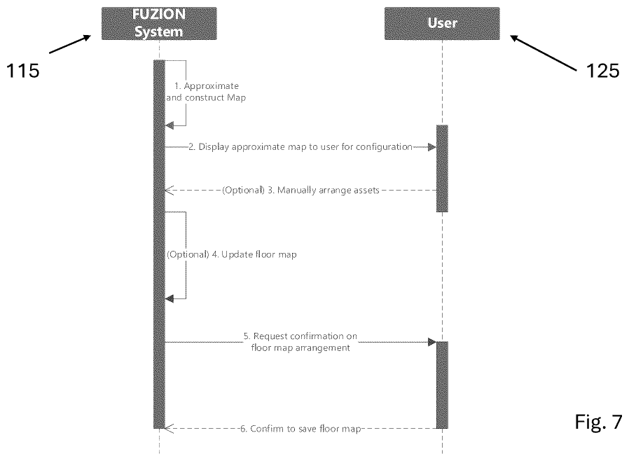

FIG. 7 is a block diagram illustrating a map finalizing process according to the embodiments of the present invention. The peripheral system 115 finalizes the floor map once all the required data are collected from the registered EGMs. The process confirms with the operator and allows adjustment if needed. Through this process, the peripheral system 115 creates a working floor map for micro-positioning functions as detailed herein. The process comprises (i) the peripheral system 115 approximates and constructs a floor map using data collected; (ii) prompt and display floor map to operator for configuration and confirmation; (iii) operator can manually adjust and arrange EGMs if needed; (iv) the peripheral system 115 updates the floor map using operator input, if any; (v) the peripheral system 115 requests confirmation of the floor map arrangement from the operator; and (vi) the peripheral system 115 saves and begins using the configured floor map.

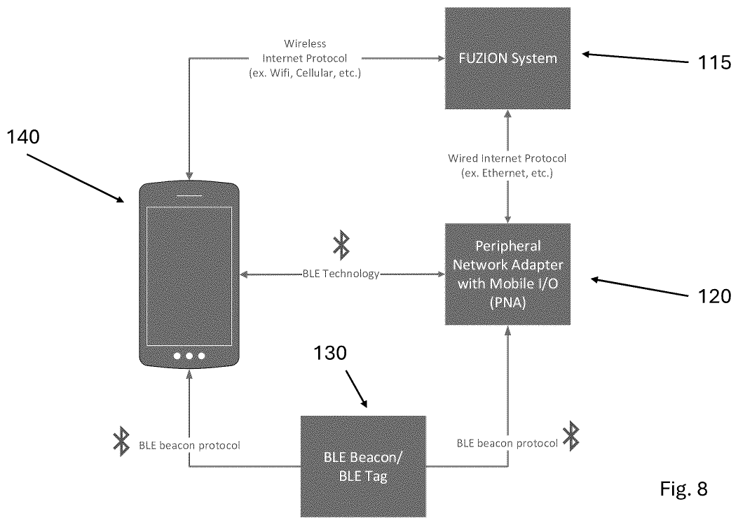

FIG. 8 is a block diagram showing possible connections according to the embodiments of the present invention. All connections shown may not be present in every system. See the descriptions below for information regarding the interconnectivity of the components in different embodiments. In many use cases, there is more than one of each system component and a single peripheral system 115 to manage all the system components within a casino environment. FIG. 8 shows that (i) the mobile device 140 may communicate with the peripheral system 115 directly or through one or more PNAs 120 and may receive messages from one or more BLE beacons/BLE tags 130; (ii) the PNA 120 may communicate with the peripheral system 115, one or more mobile devices 140 and/or one or more PNAs 120 and may receive messages from one or more BLE beacons/BLE tags 130; (iii) the BLE beacon/BLE tag 130 may broadcast messages to one or more PNAs 120 and/or may broadcast messages to one or more mobile devices 140; and (iv) the peripheral system 115 may communicate with one or more PNAs 120 and/or one or more mobile devices 140. As used herein, BLE beacons are fixed and BLE tags are mobile but those skilled in the art will recognize that the devices use the same technology.

An approximation of the physical distance between BLE enabled devices can be calculated based on the detected Received Signal Strength Indicator (RSSI) value between the receiver and a nearby BLE capable device. This calculation can be made by either the peripheral system 115, PNA 120, or mobile device 140. With the peripheral system 115, the peripheral system 115 receives data from PNAs 120 and mobile devices 140, where they act as receivers for BLE signals from nearby BLE beacons 130, the peripheral system 115 cross-references that information against the floor map built during the system setup to approximate the distance between and the surrounding devices and update the related information.

Using a PNA 120, the PNA 120 receives BLE signals from nearby BLE beacons 130, and utilize the data sent by the surrounding devices to approximate the distance between itself and the other devices. Afterwards, the PNA 120 relays the distance information to the peripheral system 115, such that the peripheral system 115 can cross-reference the information against the floor map built during the system setup to update the related information. Using the mobile device 140, the mobile device 140 receives BLE signals from nearby BLE beacons 130, and utilize the data sent by the surrounding devices to approximate the distance between itself and other devices. Afterwards, the mobile device 140 sends a notification to the peripheral system 115 that it is attempting to calculate its own location, and the peripheral system 115 in return sends the casino floor map built during the system setup. Given that the mobile device 140 has approximated the distance between itself and the surrounding devices and has the floor map as a reference, the mobile device 140 is able to determine its own location relative to the floor map, and later notify the peripheral system 115 of its location on the floor map.

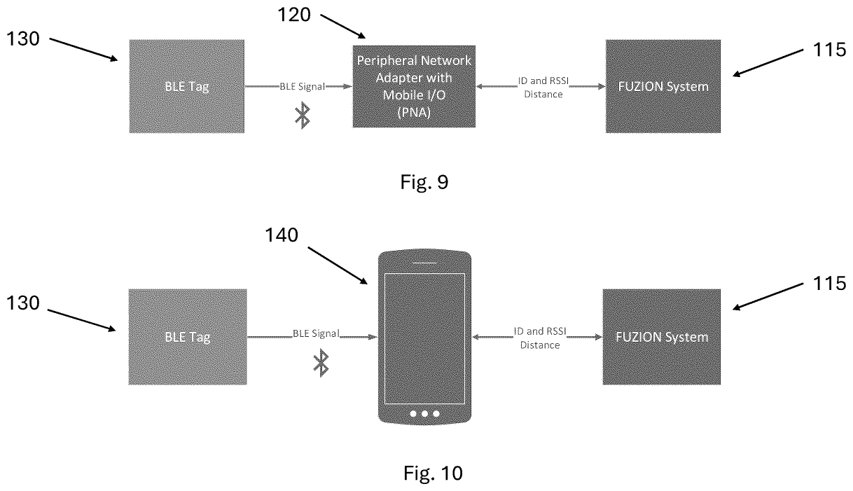

FIG. 9 is a block diagram illustrating an arrangement of components to approximate the distance from a BLE tag 130 to a PNA 120 according to the embodiments of the present invention. The proximity of a movable BLE beacon 130 in relation to another BLE beacon 130 device is one key element for the peripheral system 115 to provide micro-positioning support. A movable BLE beacon 130 that broadcasts BLE signals may have its location approximated by a receiver, which allows the peripheral system 115 to determine how close the movable BLE beacon 130 is to the receiver. The PNA 120 receives BLE signals from the BLE beacon/tag 130 and reports the BLE beacon's/tag's ID and RSSI to the peripheral system 115. Given the RSSI of the BLE beacon/tag 130, the distance between the BLE beacon/tag 130 and PNA 120 can be calculated by either the PNA 120 or the peripheral system 115.

FIG. 10 is a block diagram illustrating an arrangement of components to approximate the distance from a BLE beacon/tag 130 to a mobile device 140 according to the embodiments of the present invention. A nearby mobile device 140 receives BLE signals from the BLE beacon/tag 130 and report the BLE beacon's/tag's ID and RSSI to the peripheral system 115. Given the BLE beacon's/tag's reported RSSI, the distance between the BLE beacon/tag 130 and mobile device 140 can be calculated by either the mobile device 140 or peripheral system 115.

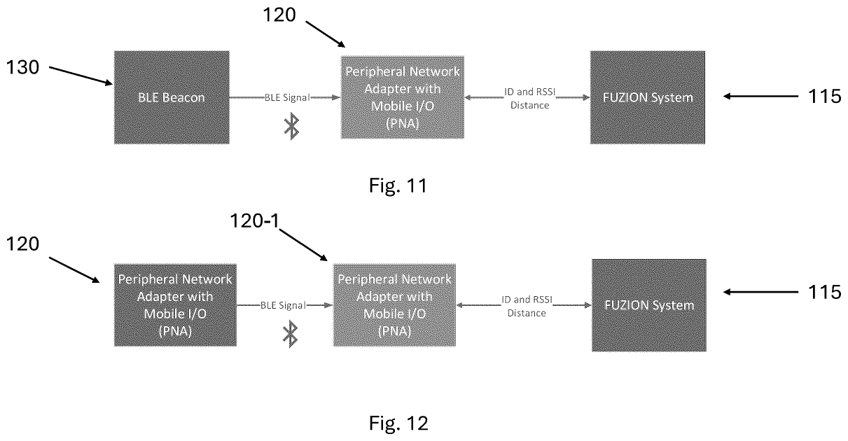

FIG. 11 is a block diagram illustrating an arrangement of components to approximate the distance from a PNA 120 to a BLE beacon 130 according to the embodiments of the present invention. The PNA 120 receives BLE signals from the nearest BLE beacon 130 and reports the BLE ID and RSSI of the BLE beacon 130 to the peripheral system 115. Given the reported RSSI of the BLE beacon 130, the distance between the BLE beacon 130 and PNA 120 can be calculated by either the PNA 120 or peripheral system 115.

FIG. 12 is a block diagram illustrating an arrangement of components to approximate the distance from a PNA 120 to another PNA 120-1 according to the embodiments of the present invention. A PNA 120-1 receives BLE signals from another nearby PNA 120 and reports the ID and RSSI of the nearby PNA 120 to the peripheral system 115. Given the reported RSSI of the nearby PNA 120, the distance between the two PNAs 120, 120-1 can be calculated by either the PNA 120-1 receiving the BLE signals or peripheral system 115.

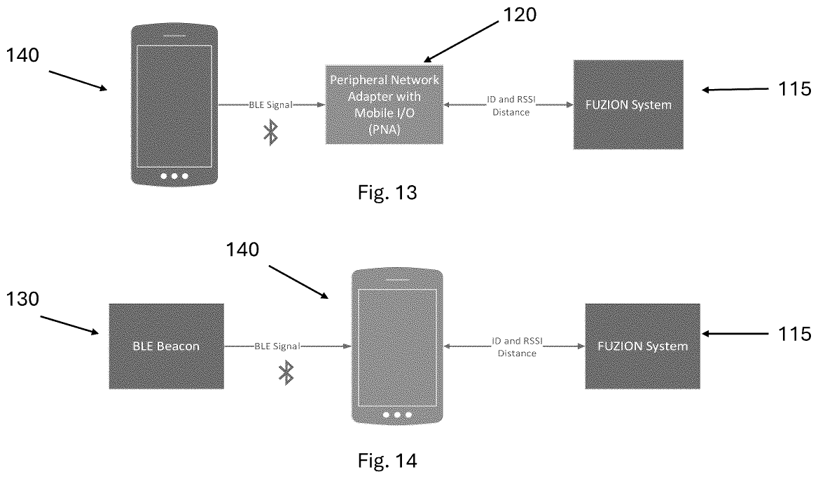

FIG. 13 is a block diagram illustrating an arrangement of components to approximate the distance from a PNA 120 to a mobile device 140 according to the embodiments of the present invention. A PNA 120 receives BLE signals from a nearby mobile device 140 and reports the ID and RSSI of a nearby mobile device 140 to the peripheral system 115. Given the nearby reported RSSI of the mobile device, the distance between the mobile device 140 and PNA 120 can be calculated by either the PNA 120 or peripheral system 115.

FIG. 14 is a block diagram illustrating an arrangement of components to approximate the distance from a mobile device 140 to a BLE beacon 130 according to the embodiments of the present invention. A mobile device 140 receives BLE signals from the nearest BLE beacon 130 and reports the ID and RSSI of the BLE beacon to the peripheral system 115. Given the reported RSSI of the BLE beacon, the distance between the BLE beacon 130 and mobile device 140 can be calculated by either the mobile device 140 or peripheral system 115.

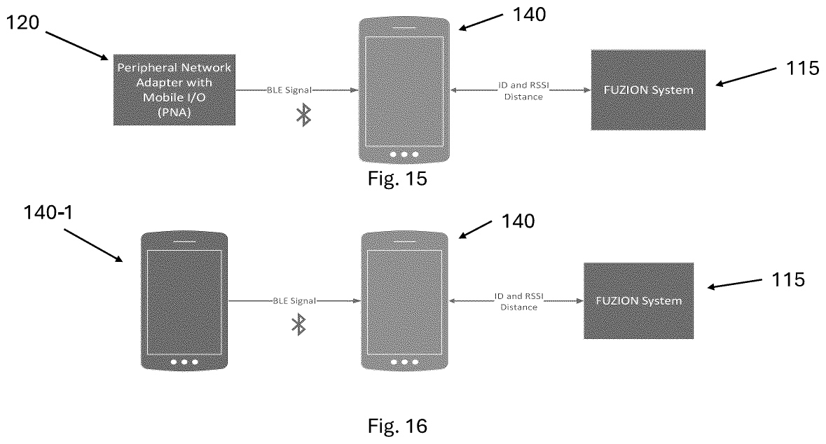

FIG. 15 is a block diagram illustrating an arrangement of components to approximate the distance from a mobile device 140 to a PNA 120 according to the embodiments of the present invention. A mobile device 140 receives BLE signals from a nearby PNA 120 and reports the nearby ID and RSSI of the PNA 120 to the peripheral system 115. Given the reported RSSI of the nearby PNA 120, the distance between the PNA 120 and mobile device 140 can be calculated by either the mobile device 140 or peripheral system 115.

FIG. 16 is a block diagram illustrating an arrangement of components to approximate the distance from a mobile device 140 to another mobile device 140-1 according to the embodiments of the present invention. A mobile device 140 receives BLE signals from another nearby mobile device 140-1 and reports the ID and RSSI of a nearby mobile device 140-1 to the peripheral system 115. Given the reported RSSI of the nearby mobile device 140, the distance between the two mobile devices 140 can be calculated by either the mobile device 140 receiving the BLE signals or peripheral system 115.

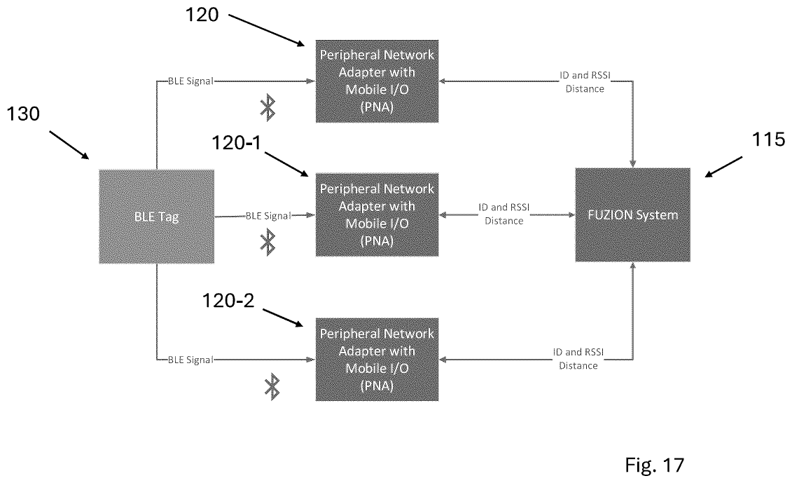

FIG. 17 is a block diagram illustrating an arrangement of components to approximate the location of a BLE beacon/tag 130 based on multiple PNAs 120, 120-1 and 120-2 reporting the BLE beacon/tag 130 according to the embodiments of the present invention. A BLE beacon/tag 130 broadcasts BLE signals, and nearby PNAs 120, 120-1 and 120-2 report the ID and RSSI of the BLE beacon/tag 130 to the peripheral system 115. Given the reported RSSI of the BLE beacon/tag 130, the distance of the BLE beacon/tag 130 to each of the nearby PNAs 120, 120-1 and 120-2 can be calculated by either the PNAs 120, 120-1 or 120-2 or by the peripheral system 115. The location of the BLE beacon/tag 130 is determined based on the positions of each of the PNAs 120, 120-1 and 120-2 receiving BLE signals and their respective distance from the BLE beacon/tag 130. While three PNAs 120, 120-1 and 120-2 are shown, more or less PNAs 120, 120-1 and 120-2 may be used in this embodiment.

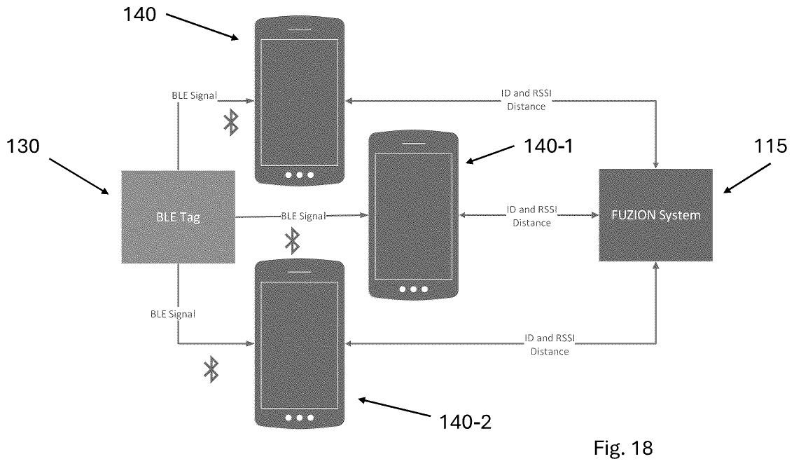

FIG. 18 is a block diagram illustrating an arrangement of components to approximate the location of a BLE beacon/tag 130 based on multiple mobile devices 140, 140-1 and 140-2 reporting the BLE beacon/tag 130 according to the embodiments of the present invention. A BLE beacon/tag 130 broadcasts BLE signals, and nearby mobile devices 140, 140-1 and 140-2 report the ID and RSSI of the BLE beacon/tag to the peripheral system 115. Given the reported RSSI of the BLE beacon/tag 130, the distance of the BLE beacon/tag 130 to each of the nearby mobile devices 140, 140-1 and 140-2 can be calculated by either the mobile devices 140, 140-1 and 140-2 or by the peripheral system 115. The location of the BLE beacon/tag 130 is determined based on the positions of each of the mobile devices 140, 140-1 and 140-2 receiving BLE signals and their respective distance from the BLE beacon/tag 130.

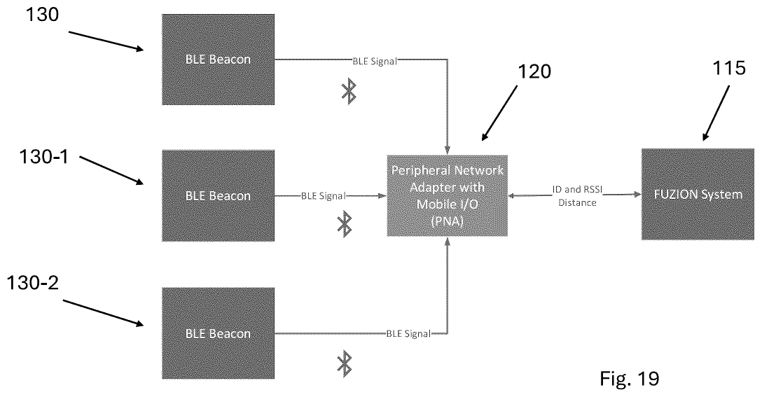

FIG. 19 is a block diagram illustrating a first arrangement of components to approximate the location of a PNA 120 according to the embodiments of the present invention. A PNA 120 receive BLE signals from nearby BLE beacons 130, 130-1 and 130-2 and reports the ID and RSSI for each of the BLE beacons 130, 130-1 and 130-2 to the peripheral system 115. Given the reported RSSI for each of the BLE beacons 130, 130-1 and 130-2, the distance between the PNA 120 and each of the BLE beacons 130, 130-1 and 130-2 can be calculated by either the PNA 120 or the peripheral system 115. The location of the PNA 120 is determined based on the positions of each of the BLE beacons 130, 130-1 and 130-2 sending BLE signals and their respective distance from the PNA 120. While three beacons 130, 130-1 and 130-2 are shown, more or less BLE beacons 130, 130-1 and 130-2 may be used in this embodiment.

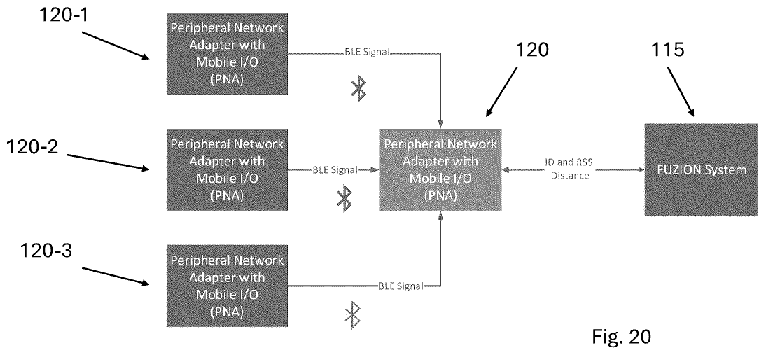

FIG. 20 is a block diagram illustrating a second arrangement of components to approximate the location of a PNA 120 according to the embodiments of the present invention. A PNA 120 receives BLE signals from other nearby PNAs 120-1, 120-2 and 120-3 and reports the ID and RSSI for each of the nearby PNAs 120-1, 120-2 and 120-3 to the peripheral system 115. Given the reported RSSI for each of the nearby PNAs 120-1, 120-2 and 120-3, the distance between the PNA 120 and each of the nearby PNAs 120-1, 120-2 and 120-3 can be calculated by either the PNA 120 receiving BLE signals or the peripheral system 115. The location of the PNA 120 is determined based on the positions of each of the nearby PNAs 120-1, 120-2 and 120-3 sending BLE signals and their respective distance from the PNA 120 receiving the BLE signals.

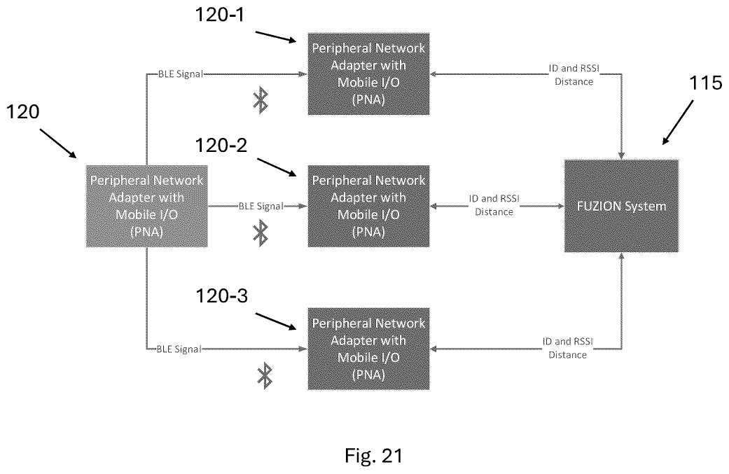

FIG. 21 is a block diagram illustrating a third arrangement of components to approximate the location of a PNA 120 according to the embodiments of the present invention. A PNA 120 broadcasts BLE signals, and other nearby PNAs 120-1, 120-2 and 120-3 report ID and RSSI of PNA 120 to the peripheral system 115. Given the RSSI of the PNA 120, the distance of the PNA 120 broadcasting BLE signals to each of the nearby PNAs 120-1, 120-2 and 120-3 receiving the BLE signals can be calculated by either the nearby PNAs 120-1, 120-2 and 120-3 or by the peripheral system 115. The location of the PNA 120 is determined based on the positions of each of the nearby PNAs 120-1, 120-2 and 120-3 receiving BLE signals and their respective distance from the PNA 120 broadcasting the BLE signals.

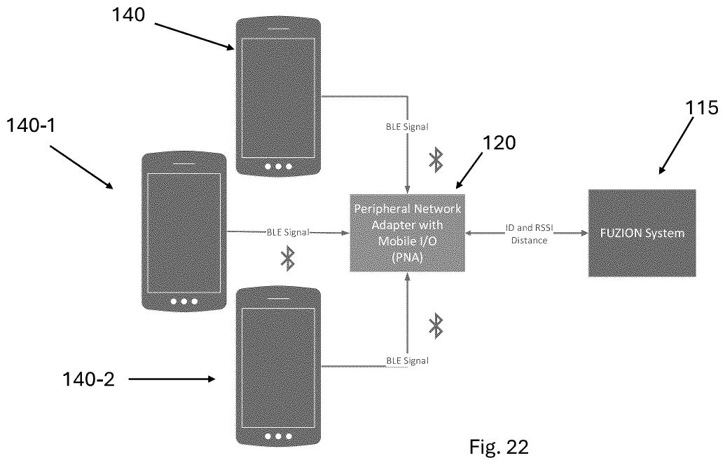

FIG. 22 is a block diagram illustrating a fourth arrangement of components to approximate the location of a PNA 120 according to the embodiments of the present invention. A PNA 120 receives BLE signals from nearby mobile devices 140, 140-1 and 140-2 and reports the ID and RSSI for each of the mobile devices 140, 140-1 and 140-2 to the peripheral system 115. Given the reported RSSI for each of the mobile devices 140, 140-1 and 140-2, the distance between the PNA 120 and each of the mobile devices 140, 140-1 and 140-2 can be calculated by either the PNA 120 or the peripheral system 115. The location of the PNA 120 is determined based on the positions of each of the mobile devices 140, 140-1 and 140-2 sending BLE signals and their respective distance from the PNA 120.

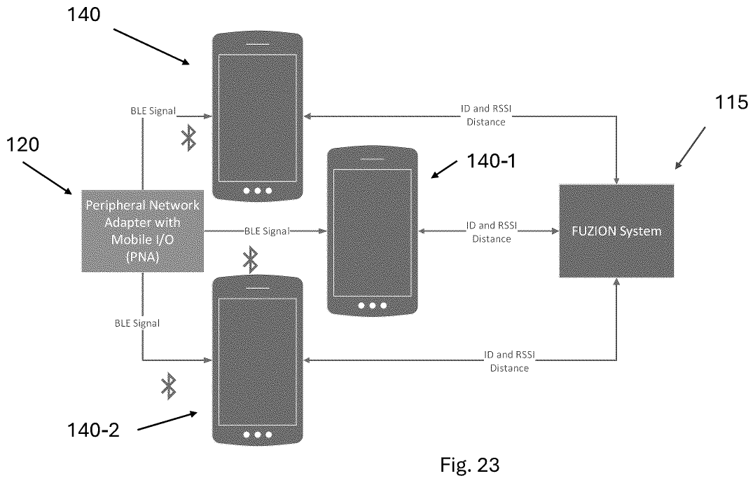

FIG. 23 is a block diagram illustrating a fifth arrangement of components to approximate the location of a PNA 120 according to the embodiments of the present invention. A PNA 120 broadcasts BLE signals, and nearby mobile devices 140, 140-1 and 140-2 report the ID and RSSI of the PNA 120 to the peripheral system 115. Given the reported RSSI of the PNA 120, the distance of the PNA 120 to each of the nearby mobile devices 140, 140-1 and 140-2 can be calculated by either the mobile devices 140, 140-1 and 140-2 or by the peripheral system 115. The location of the PNA 120 is determined based on the positions of each of the mobile devices 140, 140-1 and 140-2 receiving BLE signals and their respective distance from the PNA 120.

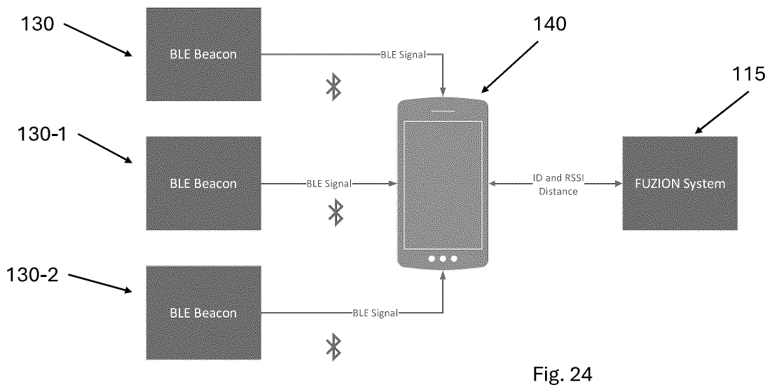

FIG. 24 is a block diagram illustrating a first arrangement of components to approximate the location of a mobile device 140 according to the embodiments of the present invention. A mobile device 140 receives BLE signals from nearby BLE beacons 130, 130-1 and 130-2 and reports the ID and RSSI for each of the BLE beacons 130, 130-1 and 130-2 to the peripheral system 115. Given the reported RSSI for each of the BLE beacons 130, 130-1 and 130-2, the distance between the mobile device 140 and each of the BLE beacons 130, 130-1 and 130-2 can be calculated by either the mobile device 140 or the peripheral system 115. The location of the mobile device 140 is determined based on the positions of each of the BLE beacons 130, 130-1 and 130-2 sending BLE signals and their respective distance from the mobile device 140.

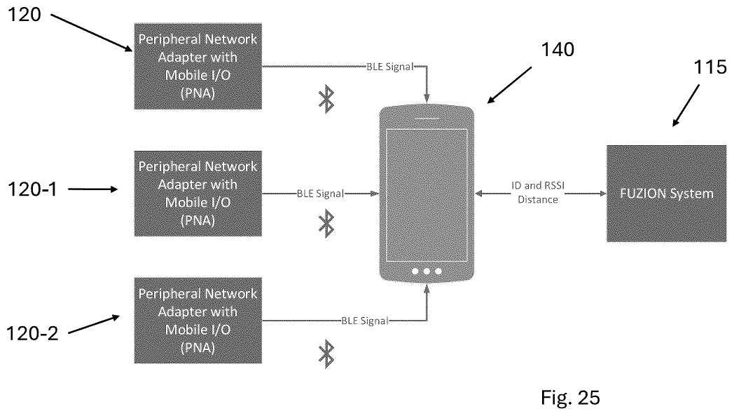

FIG. 25 is a block diagram illustrating a second arrangement of components to approximate the location of a mobile device 140 according to the embodiments of the present invention. A mobile device 140 receives BLE signals from nearby PNAs 120, 120-1 and 120-2 and reports the ID and RSSI for each of the PNAs 120, 120-1 and 120-2 to the peripheral system 115. Given the reported RSSI for each of the PNAs 120, 120-1 and 120-2, the distance between the mobile device 140 and each of the PNAs 120, 120-1 and 120-2 can be calculated by either the mobile device 140 or the peripheral system 115. The location of the mobile device is determined based on the positions of each of the PNAs 120, 120-1 and 120-2 sending BLE signals and their respective distance from the mobile device 140.

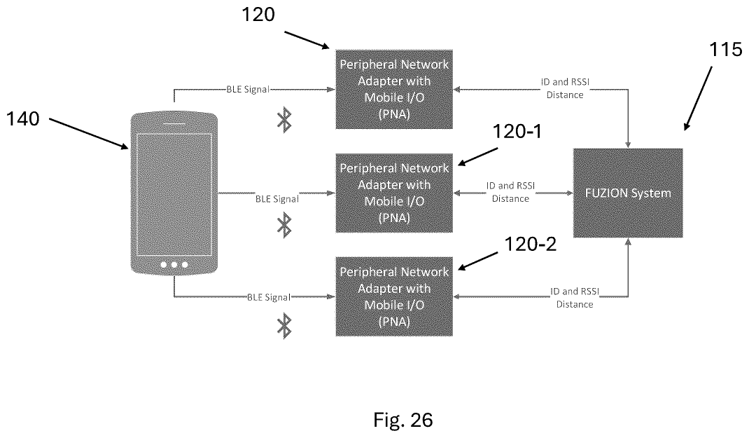

FIG. 26 is a block diagram illustrating a third arrangement of components to approximate the location of a mobile device 140 according to the embodiments of the present invention. A mobile device 140 broadcasts BLE signals, and nearby PNAs 120, 120-1 and 120-2 report the ID and RSSI of the mobile device 140 to the peripheral system 115. Given the reported RSSI of the mobile device 140, the distance of the mobile device 140 to each of the nearby PNAs 120, 120-1 and 120-2 can be calculated by either the PNAs 120, 120-1 and 120-2 or by the peripheral system 115. The location of the mobile device is determined based on the positions of each of the PNAs 120, 120-1 and 120-2 receiving BLE signals and their respective distance from the mobile device 140.

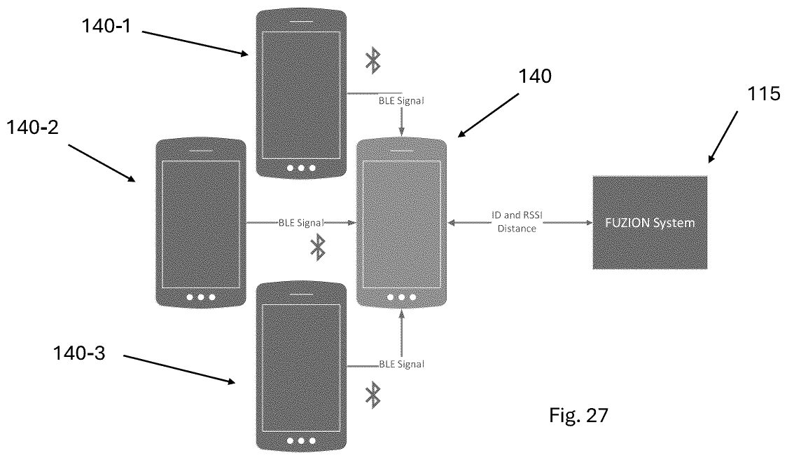

FIG. 27 is a block diagram illustrating a fourth arrangement of components to approximate the location of a mobile device 140 according to the embodiments of the present invention. A mobile device 140 receives BLE signals from other nearby mobile devices 140-1, 140-2 and 140-3 and reports the ID and RSSI for each of the nearby mobile devices 140-1,140-2, and 140-3 to the peripheral system 115. Given the reported RSSI for each of the nearby mobile devices 140-1, 140-2 and 140-3, the distance between the mobile device 140 and each of the nearby mobile devices 140-1, 140-2 and 140-3 can be calculated by either the mobile device 140 receiving BLE signals or the peripheral system 115. The location of the mobile device 140 is determined based on the positions of each of the nearby mobile devices 140-1, 140-2 and 140-3 sending BLE signals and their respective distance from the mobile device 140 receiving the BLE signals.

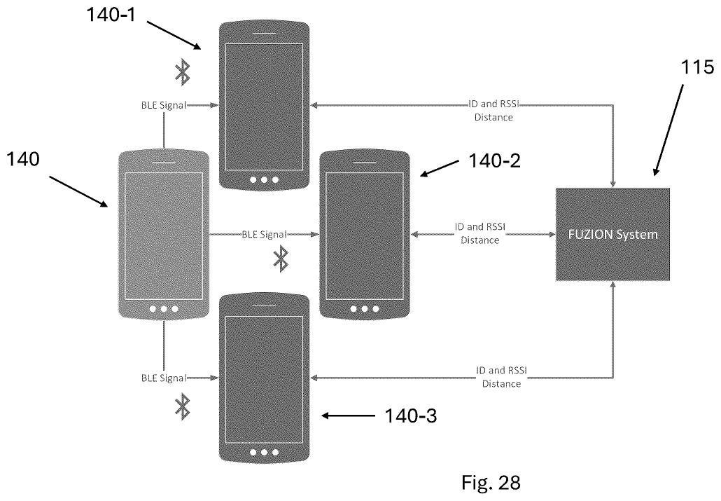

FIG. 28 is a block diagram illustrating a fifth arrangement of components to approximate the location of a mobile device 140 according to the embodiments of the present invention. A mobile device 140 broadcasts BLE signals, and other nearby mobile devices 140-1, 140-2 and 140-3 report the ID and RSSI of the mobile device 140 to the peripheral system 115. Given the reported RSSI of the mobile device 140, the distance of the mobile device 140 broadcasting BLE signals to each of the nearby mobile devices 140-1, 140-2 and 140-3 receiving the BLE signals can be calculated by either the nearby mobile devices 140-1, 140-2 and 140-3 or by the peripheral system 115. The location of the mobile device 140 is determined based on the positions of each of the nearby mobile device 140-1, 140-2 and 140-3 receiving BLE signals and their respective distance from the mobile device 140 broadcasting the BLE signals.

### Patron Location and Metrics

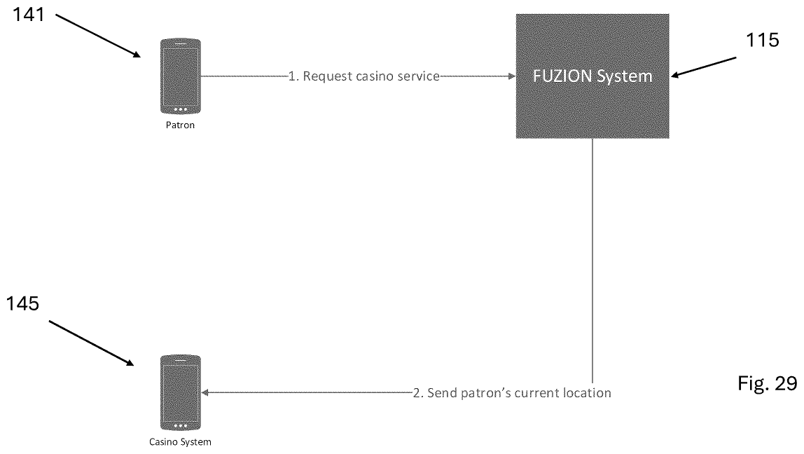

FIG. 29 is a block diagram illustrating a first arrangement of components whereby a patron may request services according to the embodiments of the present invention. In this embodiment, a patron first requests a specific casino service using their mobile device 141. Service such as food/beverage orders and/or help requests. The mobile device 141 sends the request directly to the peripheral system 115 with its current location information. The peripheral system 115 calculates and sends the patron's relative location with the requested service to casino system 145 or specific personnel.

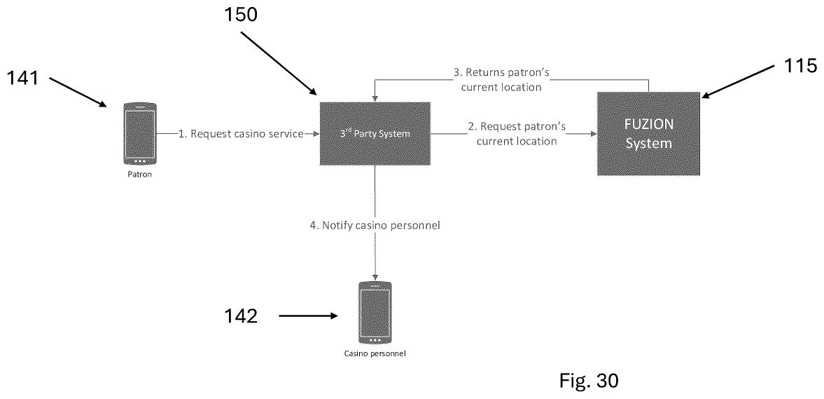

FIG. 30 is a block diagram illustrating a second arrangement of components whereby a patron may request services according to the embodiments of the present invention. In this embodiment, a patron first requests a specific casino service on their mobile device 141. Service such as food/beverage orders and/or help requests. The mobile device 141 sends the request to a 3^{rd} party system 150 along with its location. The 3^{rd} party system 150 requests the patron's current location on the floor map from the peripheral system 115. The peripheral system 115 returns the patron's current location on the floor map. The 3^{rd} party system 150 can then use the location obtained from the peripheral system 115 to notify a casino personnel 142 to handle the service.

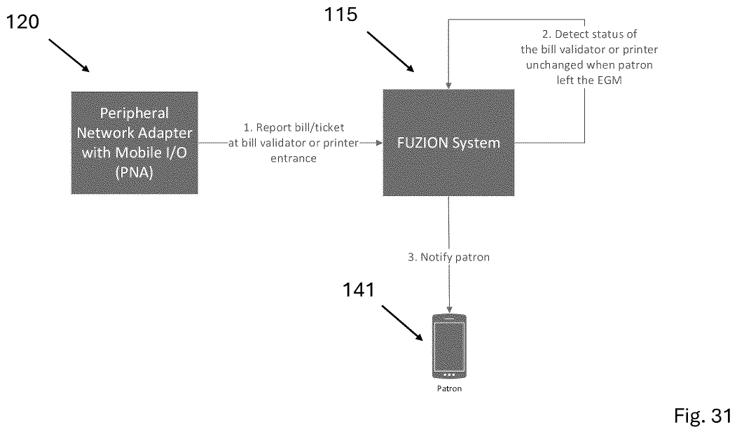

FIG. 31 is a block diagram illustrating a first arrangement of components whereby the system may notify a patron according to the embodiments of the present invention. In this embodiment, the PNA 120 detects and reports the status of the bill/ticket left at the entrance of the bill validator or printer to the peripheral system 115. The peripheral system 115 senses that the patron has moved away from the EGM with the status of the bill validator/printer unchanged. The peripheral system 115 notifies a patron's mobile device 141 to remind the patron to pick up the bill/ticket.

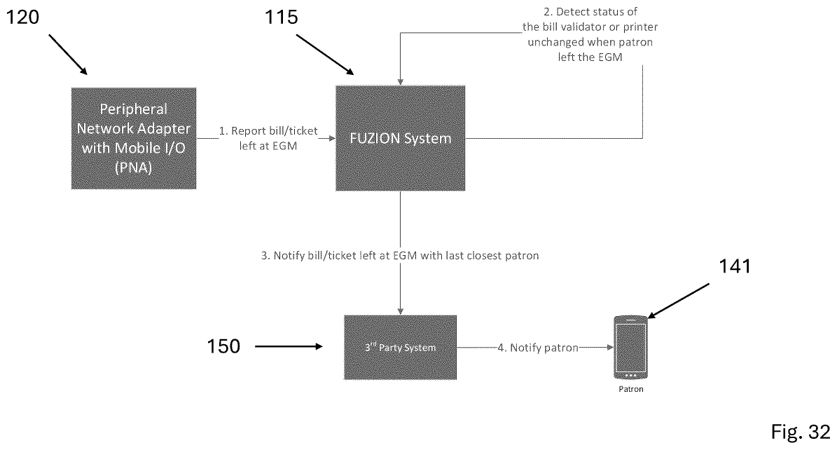

FIG. 32 is a block diagram illustrating a second arrangement of components whereby the system may notify a patron according to the embodiments of the present invention. In this instance, the PNA 120 reports the status of the bill/ticket left at the bill validator or printer to the peripheral system 115. The peripheral system 115 notifies the 3^{rd} party system 150. The 3^{rd} party system notifies the patron's mobile 141.

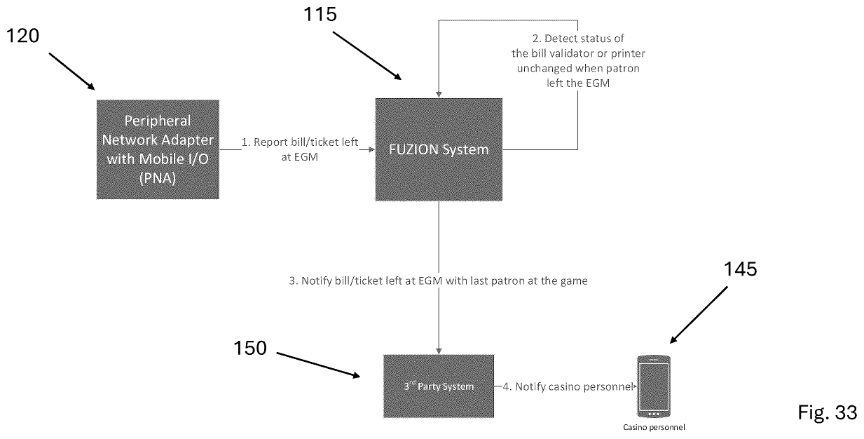

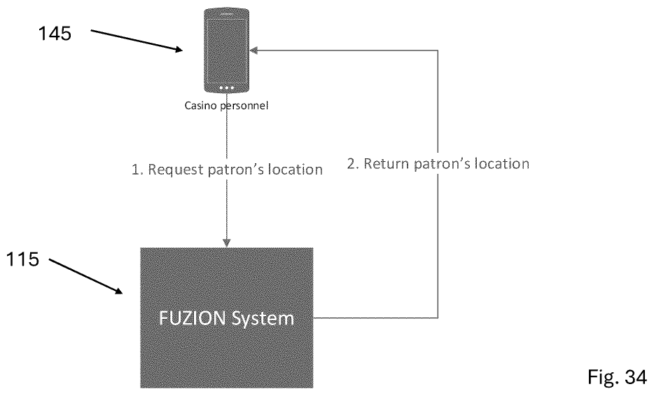

FIG. 33 is a block diagram illustrating an arrangement of components whereby the system may handle a forgotten or lost ticket according to the embodiments of the present invention. As shown, the peripheral system 115 senses the patron has moved away from the EGM with the status of the bill validator/printer unchanged. The peripheral system 115 notifies the 3^{rd} party system 150 with the identifiable information of the last patron at the EGM. The 3^{rd} party system 150 notifies casino personnel 145 to handle the issue.

FIG. 34 is a block diagram of a first arrangement of components whereby the system may track the location of a patron's smart device according to the embodiments of the present invention. First, casino personnel 145 initiates a request for the location of a specific patron's device and, next the peripheral system 115 returns the last known location of the patron's device.

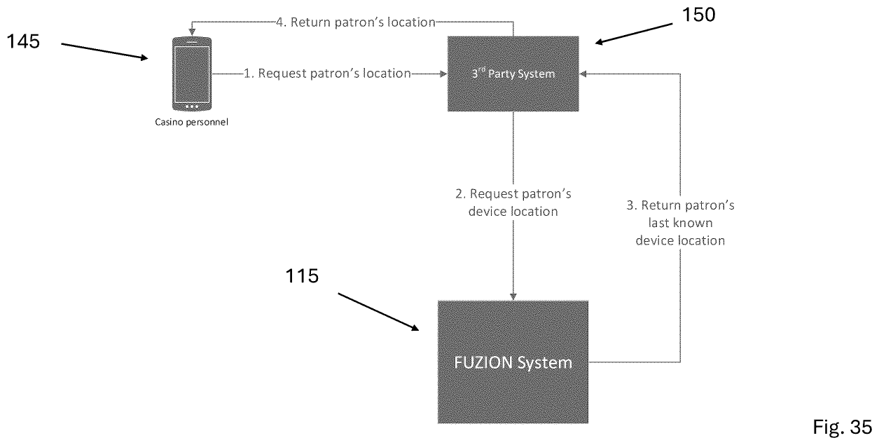

FIG. 35 is a block diagram of a second arrangement of components whereby the system may track the location of a patron's smart device according to the embodiments of the present invention. First, casino personnel 145 initiates a request through the 3^{rd} party system 150. The 3^{rd} party system 150 then requests the patron's device location through the peripheral system 115 which returns the last known device location to 3^{rd} party system 150. The 3^{rd} party system 150 returns the patron's smart device's location to casino personnel 145.

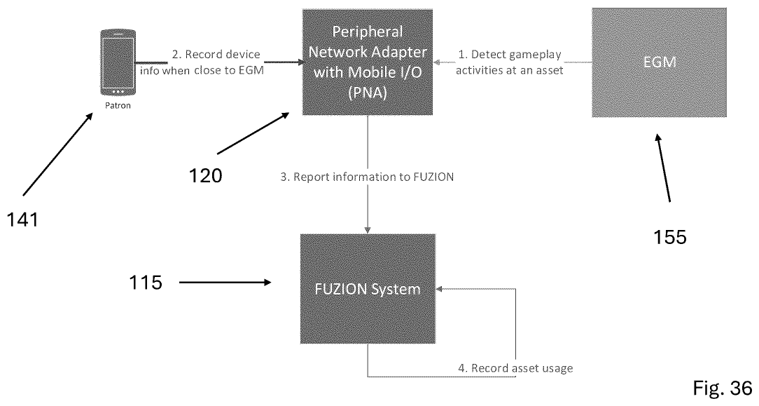

FIG. 36 a block diagram of a first arrangement of components whereby the system may track EGM usage according to the embodiments of the present invention. As detailed, the peripheral system 115 may calculate EGM 155 usage based on regular reporting from the PNA devices 120 installed on the casino floor. Using those reports, the peripheral system 115 may display metrics such as a heatmap, asset usage, time spent at EGM 155, etc. The PNA 120 detects gameplay activities at an EGM 155. The PNA 120 records the patron's mobile device 141 information near the EGM 155 and reports the same to the peripheral system 115. The peripheral system 115 compiles EGM 155 usages.

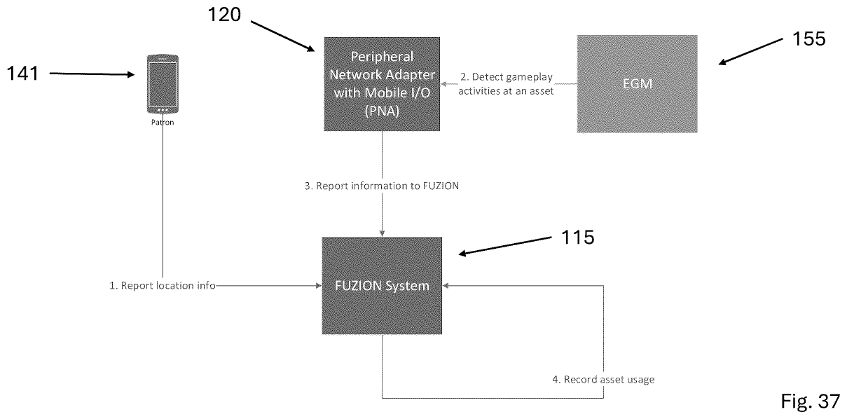

FIG. 37 is a block diagram of a second arrangement of components whereby the system may track EGM 155 usage according to the embodiments of the present invention. The patron's mobile device 141 reports its location regularly to the peripheral system 115. The PNA 120 detects gameplay activities at an EGM 155 and reports the gameplay metrics to the peripheral system 115. The peripheral system 115 compiles and associates the gameplay metrics with the patron's information.

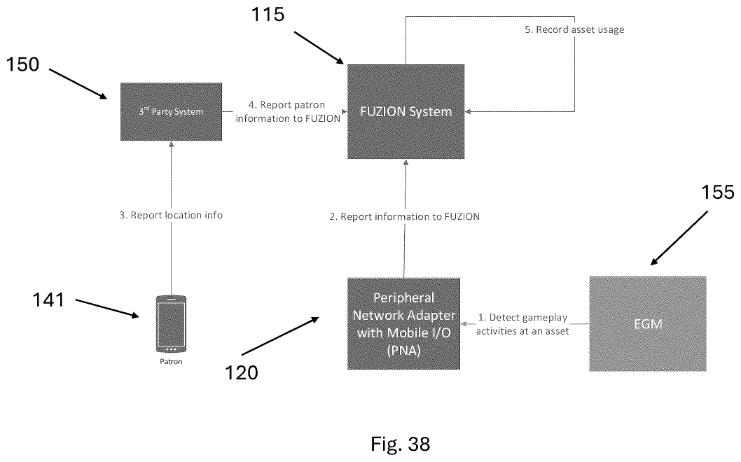

FIG. 38 is a block diagram of a third arrangement of components whereby the system may track EGM usage according to the embodiments of the present invention. The PNA 120 detects gameplay activities at an EGM 155 and reports information to the peripheral system 115. The patron's mobile device 141 reports its location information to the 3^{rd} party system 150. The 3^{rd} party system 150 reports the patron's mobile device 141 information to the peripheral system 115. Once both pieces of information are collected, the peripheral system 115 consolidates the location of the patron's mobile device 141 with the EGM 155. Those skilled in the art that certain steps can be accomplished in different orders with the same results.

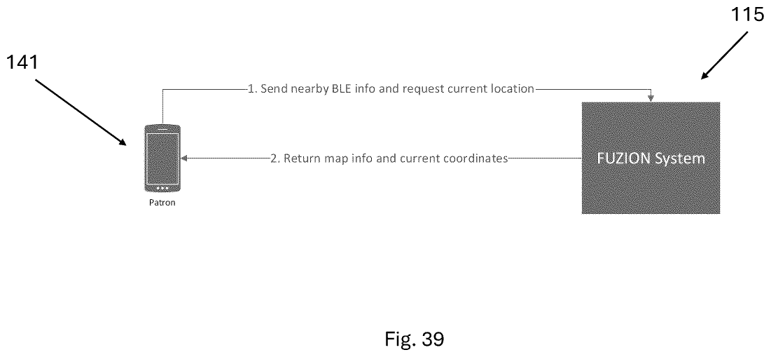

FIG. 39 is a block diagram of a first arrangement of components whereby the system may provide directions to a patron according to the embodiments of the present invention. The patron's mobile device 141 gathers nearby BLE information and sends a request to the peripheral system 115 which returns the map information and the current coordinates.

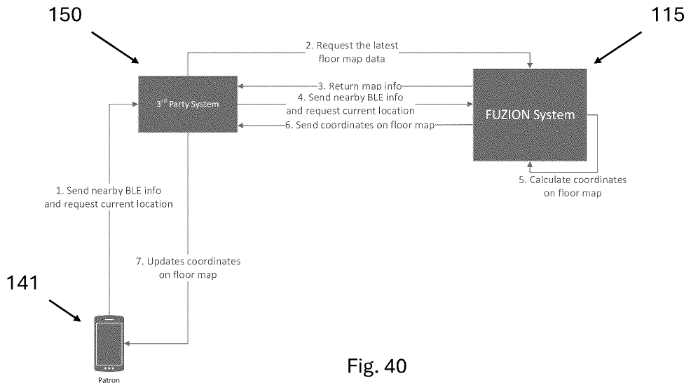

FIG. 40 is a block diagram of a second arrangement of components whereby the system may provide directions to a patron according to the embodiments of the present invention. The patron's mobile device 141 gathers nearby BLE info and makes a request for current location from 3^{rd} party system 150. The 3^{rd} party system 150 checks for and requests the latest floor map data. The peripheral system 115 returns the latest floor map data. The 3^{rd} party system 150 sends the patron's mobile device 141 info and requests location to the peripheral system 115. The peripheral system 115 calculates the coordinates on the floor map. The peripheral system 115 sends the coordinates to the 3^{rd} party system 150. The 3^{rd} party system 150 updates the coordinates on the floor map on the patron's mobile device 141.

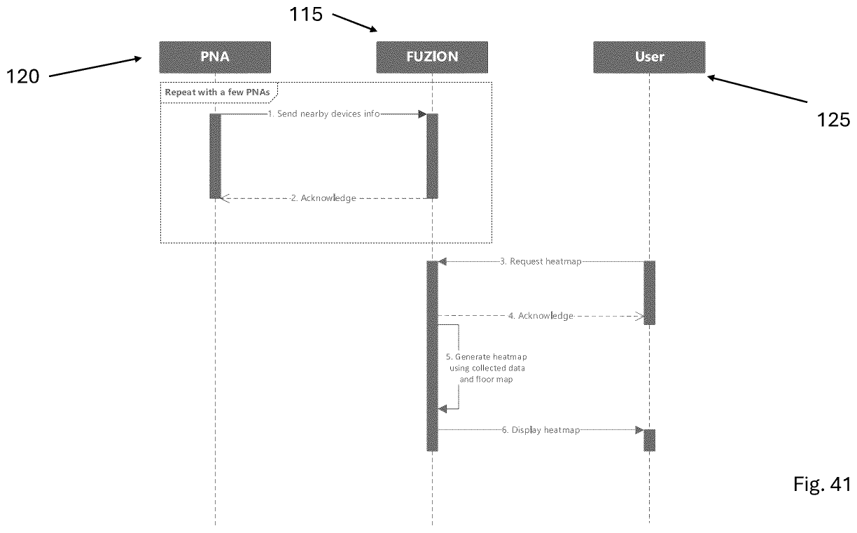

FIG. 41 is a block diagram of an arrangement of components whereby the system may provide foot traffic information to a user according to the embodiments of the present invention. The PNA 120 regularly scans the surrounding device information and sends those to the peripheral system 115. The peripheral system 115 receives the data from PNAs 120 on the casino floor. Users may request the foot traffic data from the peripheral system 115. The peripheral system 115 compiles the collected data, generates a heatmap using the floor map and displays the heatmap for the user. In one embodiment, patrons may also be provided with access to the foot traffic.

### Patron Notifications

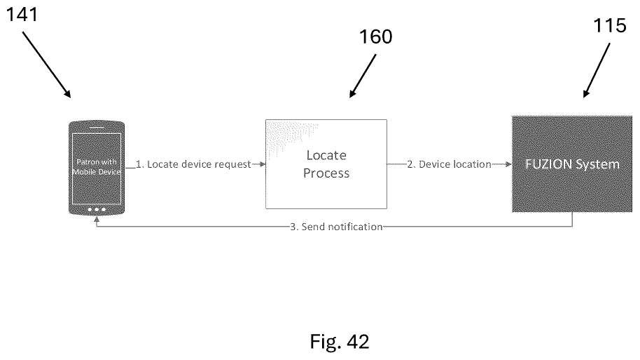

FIG. 42 is a block diagram of a first arrangement of components whereby the system may send notification to a patron according to the embodiments of the present invention. A patron with a mobile device 141 is detected nearby another BLE enabled device and request to be located. The Locate Process 160 determines the patron's location on the floor map which can be calculated by either the peripheral system 115 or a mobile application. The peripheral system 115 sends a notification to the patron's mobile device 141.

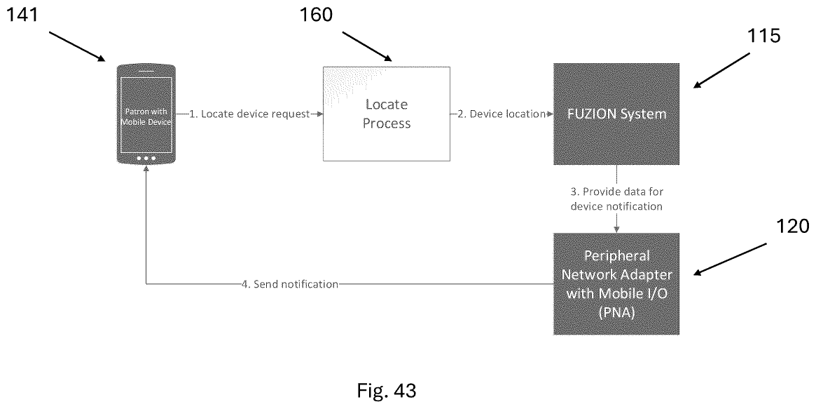

FIG. 43 is a block diagram of a second arrangement of components whereby the system may send notification to a patron according to the embodiments of the present invention. A patron with a mobile device 141 is detected nearby another BLE enabled device and requests to be located. The Locate Process 160 determines the patron's mobile device's 141 location on the floor map which can be calculated by either the peripheral system 115, PNA 120 or a mobile application. The peripheral system 115 sends data to the PNA 120 closest to the patron to build the content for the notification. The PNA 120 sends a notification to the patron's mobile device 141.

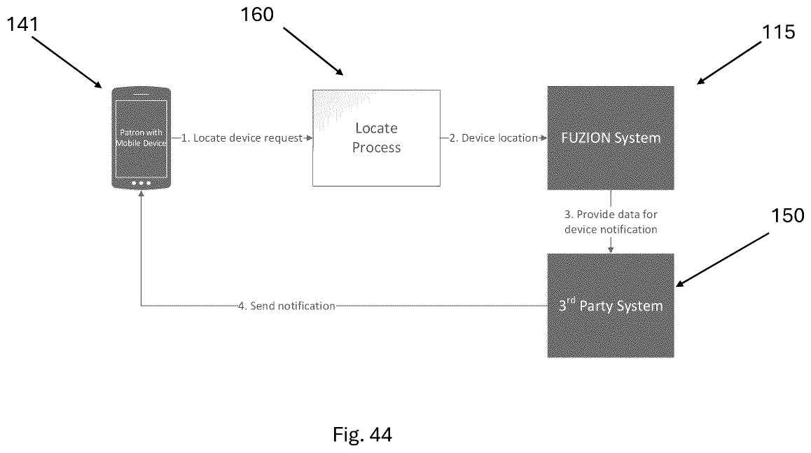

FIG. 44 is a block diagram of a third arrangement of components whereby the system may send notification to a patron according to the embodiments of the present invention. A patron with a mobile device 141 is detected nearby another BLE enabled device and requests to be located. The Locate Process 160 determines the patron's mobile device's 141 location on the floor map which can be calculated by either the peripheral system 115 or a mobile application. The peripheral system 115 sends data to the 3^{rd} party system 150 to build the content for the notification. The 3^{rd} party system 150 sends a notification to the patron's mobile device 141.

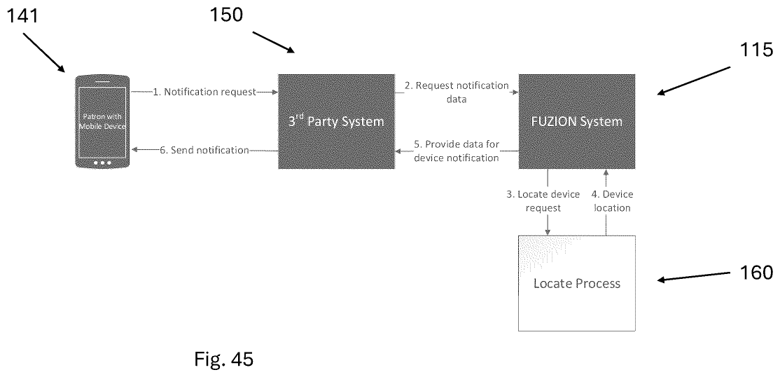

FIG. 45 is a block diagram of a fourth arrangement of components whereby the system may send notification to a patron according to the embodiments of the present invention. A patron with a mobile device 141 is requesting to be located. The 3^{rd} party system 150 requests for the patron's mobile device 141 to be located. The peripheral system 115 provides data for the Locate Process 160 to identify where the patron's mobile device 141 is located which can be calculated by either the peripheral system 115 or a mobile application. The Locate Process 160 returns the patron's mobile device's 141 location on the floor map to the peripheral system 115. The peripheral system 115 sends data to the 3^{rd} party system 150 to build the content for the notification. The 3^{rd} party system 150 sends a notification to the patron's mobile device 141.

In some embodiments, a casino property may have slot technicians receive notifications regarding the state of devices within the EGM when the slot technician's mobile device is nearby an EGM. In one such embodiment, the peripheral system 115 receives bill validator and printer statuses and transactions from EGMs across the casino property in real-time. A slot technician with a mobile device can approach an EGM and their location is calculated by either the peripheral system 115, PNA 120, or a mobile application. Once the slot tech's location is determined, the peripheral system 115 sends a notification to the slot tech's mobile device, so that the slot tech can receive a summary of the statuses and transactions for the approximate EGM.

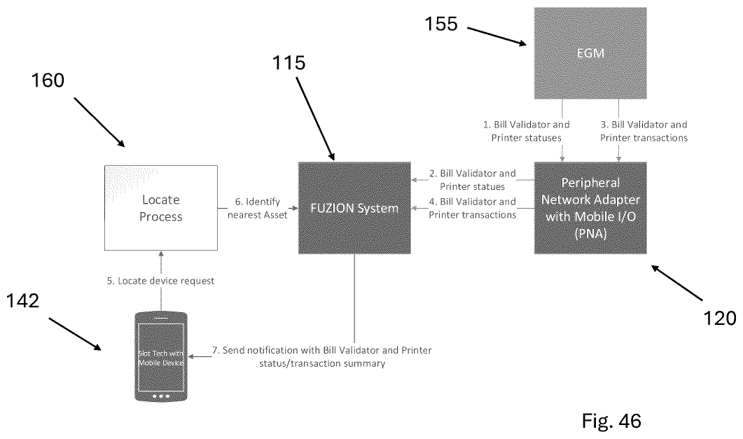

FIG. 46 is a block diagram of a first arrangement of components whereby the system may send notification to casino personnel according to the embodiments of the present invention. In this embodiment, the PNA 120 receives bill validator and printer statuses from devices inside the EGM 155. The PNA 120 sends bill validator and printer statuses to the peripheral system 115. The PNA 120 receives bill validator and printer transactions from devices inside the EGM 155. The PNA 120 sends bill validator and printer transactions to peripheral system 115. A slot tech with a mobile device 142 is detected nearby a BLE enabled device on the EGM 155 and requests to be located. The Locate Process 160 determines the slot tech's mobile device's 142 location proximity to the EGM 155 which can be calculated by either the peripheral system 115, PNA 120 or a mobile application. The peripheral system 115 sends a notification to the slot tech's mobile device 142 containing a summary of the bill validator and printer statuses and transactions for the EGM 155.

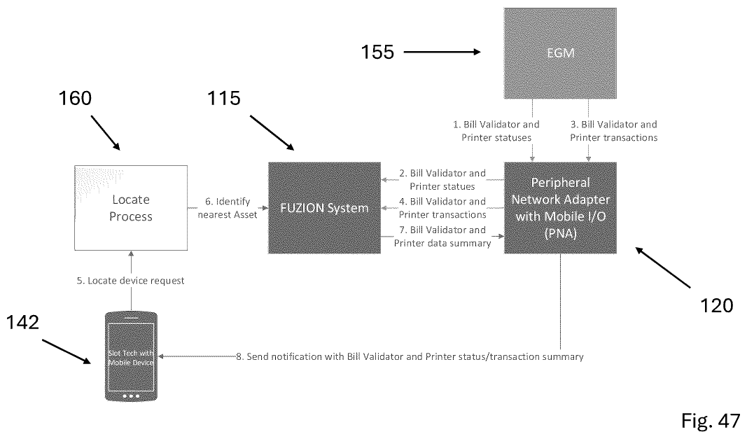

FIG. 47 is a block diagram of a second arrangement of components whereby the system may send notification to casino personnel according to the embodiments of the present invention. In this embodiment, the PNA 120 receives bill validator and printer statuses from devices inside the EGM 155. The PNA 120 sends bill validator and printer statuses to peripheral system 115. The PNA 120 receives bill validator and printer transactions from devices inside the EGM 155. The PNA 120 sends bill validator and printer transactions to peripheral system 115. A slot tech with a mobile device 142 is detected nearby a BLE enabled device on the EGM 155 and requests to be located. The Locate Process 160 determines the slot tech's mobile device's 142 location proximity to the EGM 155 which can be calculated by either the peripheral system 115, PNA 120 or a mobile application. The peripheral system 115 sends a summary of the bill validator and printer data to the PNA 120 of the EGM 155 closest to the slot tech's mobile device 142. The PNA 120 sends a notification to the slot tech's mobile device 142 containing a summary of the bill validator and printer statuses and transactions for the EGM 155.

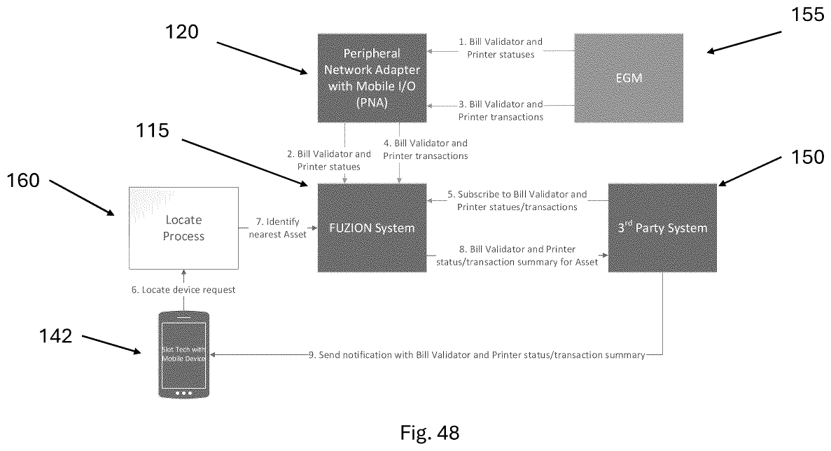

FIG. 48 is a block diagram of a third arrangement of components whereby the system may send notification to casino personnel according to the embodiments of the present invention. In this embodiment, PNA 120 receives bill validator and printer statuses from devices inside the EGM 155. The PNA 120 sends bill validator and printer statuses to the peripheral system 115. The PNA 120 receives bill validator and printer transactions from devices inside the EGM 155. The PNA 120 sends bill validator and printer transactions to the peripheral system 115. The 3^{rd} party system 150 subscribes to receiving bill validator and printer statuses and transactions from the peripheral system 115. A slot tech with a mobile device 142 is detected nearby a BLE enabled device on the EGM 155 and requests to be located. The Locate Process 160 determines the slot tech's mobile device's 142 proximity to the EGM 155 which can be calculated by either the peripheral system 115, PNA 120, or a mobile application. The peripheral system 115 sends to the 3^{rd} party system 150 a summary of the bill validator and printer data about the EGM 155 closest to the slot tech's mobile device 142. The 3^{rd} party system 150 also sends a notification to the slot tech's mobile device 142 containing a summary of the bill validator and printer statuses and transactions for the EGM 155.

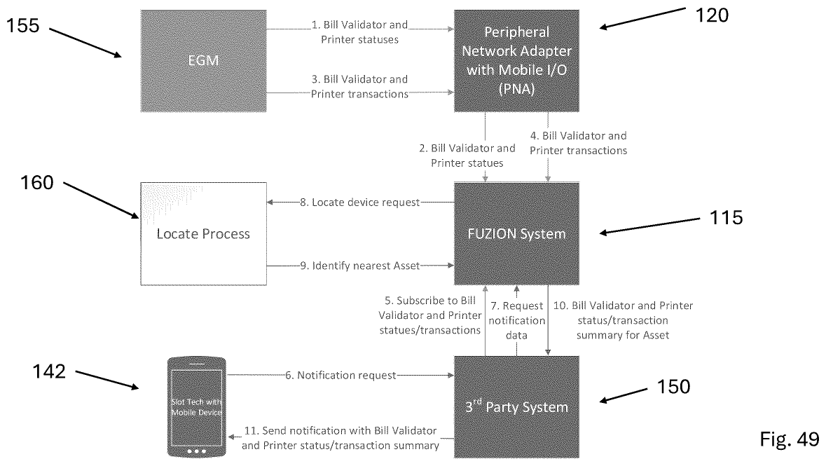

FIG. 49 is a block diagram of a fourth arrangement of components whereby the system may send notification to casino personnel according to the embodiments of the present invention. In this embodiment, PNA 120 receives bill validator and printer statuses from devices inside the EGM 155. The PNA 120 sends bill validator and printer statuses to the peripheral system 115. The PNA 120 receives bill validator and printer transactions from devices inside the EGM 155. The PNA 120 sends bill validator and printer transactions to the peripheral system 115. The 3^{rd} party system 150 subscribes to receiving bill validator and printer statuses and transactions from the peripheral system 115. A slot tech with a mobile device 142 requests to be located. The 3^{rd} party system 150 requests for the slot tech's mobile device 142 to be located. The peripheral system 115 provides data for the Locate Process 160 to identify where the slot tech's mobile device 142 is located which can be calculated by either the peripheral system 115, PNA 120, or a mobile application. The Locate Process 160 returns the slot tech's mobile device's 142 location proximity to the EGM 155 to the peripheral system 115. The peripheral system 115 sends to the 3^{rd} party system 150 a summary of the bill validator and printer data about the EGM 155 closest to the slot tech's mobile device 142. The 3^{rd} party system 150 also sends a notification to the slot tech's mobile device 142 containing a summary of the bill validator and printer statuses and transactions for the EGM 155.

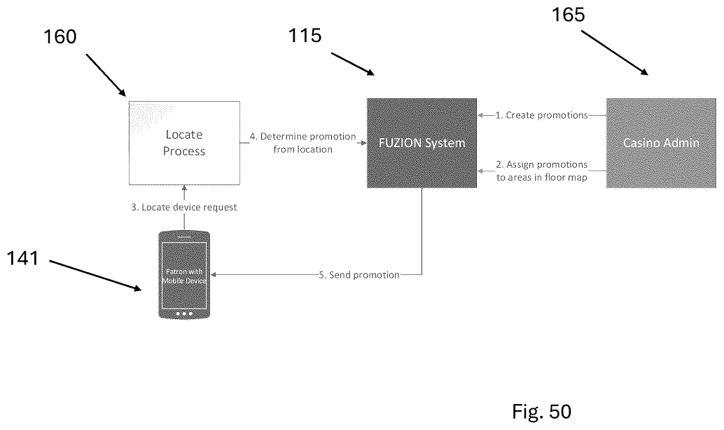

FIG. 50 is a block diagram of a first arrangement of components whereby the system may send promotions to a patron according to the embodiments of the present invention. In this embodiment, casino personnel (e.g., marketing department) or casino administrator 165 create a promotion on the peripheral system 115 or create the promotion remotely and send the promotion to the peripheral system 115. The promotion is assigned to a promotion zone on the casino floor within the peripheral system 115. A patron with a mobile device 141 is detected nearby another BLE enabled device in the promotion zone and requests to be located. The Locate Process 160 determines the patron's location, via the patron's mobile device 141, on the casino floor map which can be calculated by either the peripheral system 115 or a mobile application. The peripheral system 115 sends the promotion to the patron's mobile device 141 based on the patron being in the promotion zone.

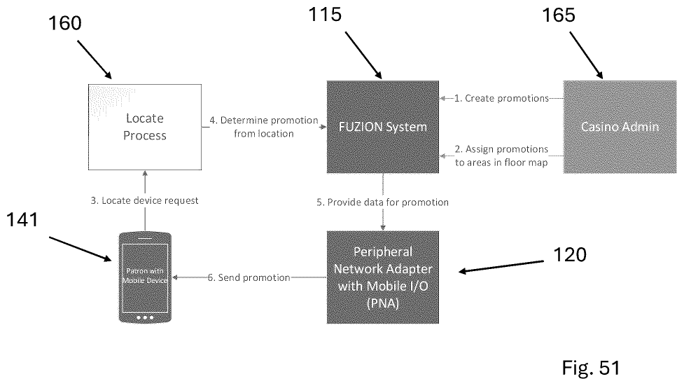

FIG. 51 is a block diagram of a second arrangement of components whereby the system may send promotions to a patron according to the embodiments of the present invention. In this embodiment, casino personnel (e.g., marketing department) or casino administrator 165 create a promotion on the peripheral system 115 or create the promotion remotely and send the promotion to the peripheral system 115. The promotion is assigned to a promotion zone on the casino floor within the peripheral system 115. A patron with a mobile device 141 is detected nearby another BLE enabled device in the promotion zone and requests to be located. The Locate Process 160 determines the patron's location, via the patron's mobile device 141, on the casino floor map which can be calculated by either the peripheral system 115 or a mobile application. Since the patron's mobile device 141 is within the promotion zone, the peripheral system 115 sends content for the promotion to the closest PNA 120 of an EGM 155 near the patron's mobile device 141. The PNA 120 with the Mobile I/O sends the promotion to the patron's mobile device 141.

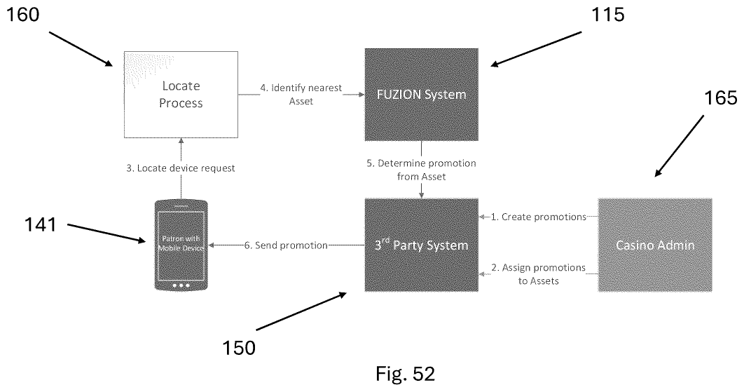

FIG. 52 is a block diagram of a third arrangement of components whereby the system may send promotions to a patron according to the embodiments of the present invention. In this embodiment, casino personnel (e.g., marketing department) or casino administrator 165 create a promotion on a 3^{rd} party system 150 and send the promotion to the peripheral system 115. The promotion is assigned to a promotion zone on the casino floor within the 3^{rd} party system 150. A patron with a mobile device 141 is detected nearby another BLE enabled device in the promotion zone and requests to be located. The Locate Process 160 determines the patron's location, via the patron's mobile device 141, on the casino floor map which can be calculated by either the peripheral system 115 or a mobile application. The peripheral system 115 notifies the 3^{rd} party system 150 of the EGM 155 the patron is most proximate. The 3^{rd} party system 150 sends the promotion to the patron's mobile device 141 as the patron is in the promotion zone.

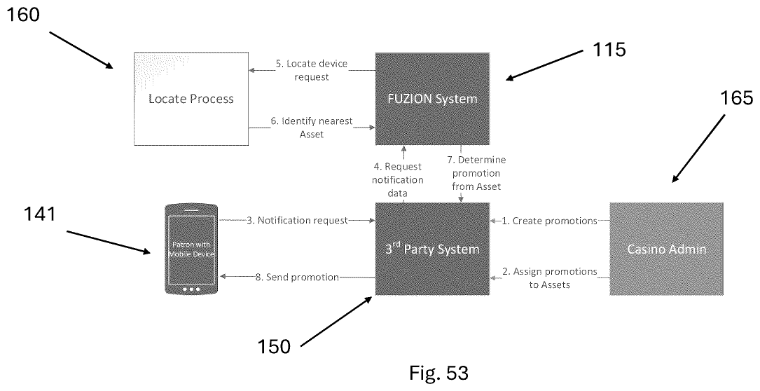

FIG. 53 is a block diagram of a fourth arrangement of components whereby the system may send promotions to a patron according to the embodiments of the present invention. In this embodiment, casino personnel (e.g., marketing department) or casino administrator 165 create a promotion on a 3^{rd} party system 150 and send the promotion to the peripheral system 115. The promotion is assigned to a promotion zone on the casino floor within the 3^{rd} party system 150. A patron with a mobile device 141 is detected nearby another BLE enabled device in the promotion zone and requests to be located. The 3^{rd} party system 150 requests for the patron's mobile device 141 to be located. The peripheral system 115 provides data for the Locate Process 160 to identify where the patron's mobile device 141 is located which can be calculated by either the peripheral system 115 or a mobile application. The Locate Process 160 returns the patron's mobile device 141 location on the casino floor map to the peripheral system 115. The peripheral system 115 notifies the 3^{rd} party system 150 of the EGM 155 to which the patron's mobile device 141 is most proximate. The 3^{rd} party system 150 sends the promotion to the patron's mobile device 141 since the patron is in the promotion zone.

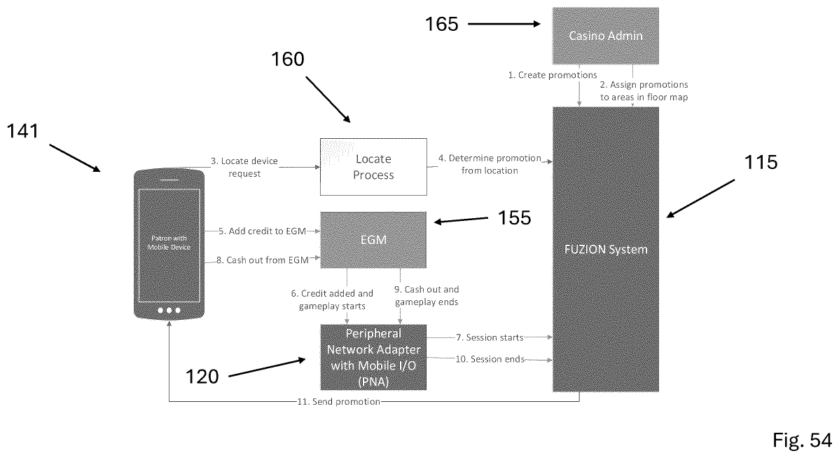

FIG. 54 is a block diagram of a first arrangement of components whereby the system may send promotions to a patron based on EGM play according to the embodiments of the present invention. In this embodiment, casino personnel (e.g., marketing department) or casino administrator 165 create a promotion on the peripheral system 115. The promotion is assigned to a promotion zone on the casino floor map by the peripheral system 115. A patron with a mobile device 141 is detected nearby a BLE enabled device on an EGM 155 in the promotion zone and requests to be located. The Locate Process 160 determines the patron's mobile device's 141 location proximity to the EGM 155 which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started. Once the patron has completed their EGM gameplay session, the patron cashes out from the EGM 155. The PNA 120 is notified that the cash out occurred at the EGM 155 and the EGM gameplay session has ended. The PNA 120 sends a notification to the peripheral system 115 that the ongoing EGM gameplay session has ended. The peripheral system 115 sends the promotion to the patron's mobile device 141 based on completion of EGM gameplay (i.e., cashout).

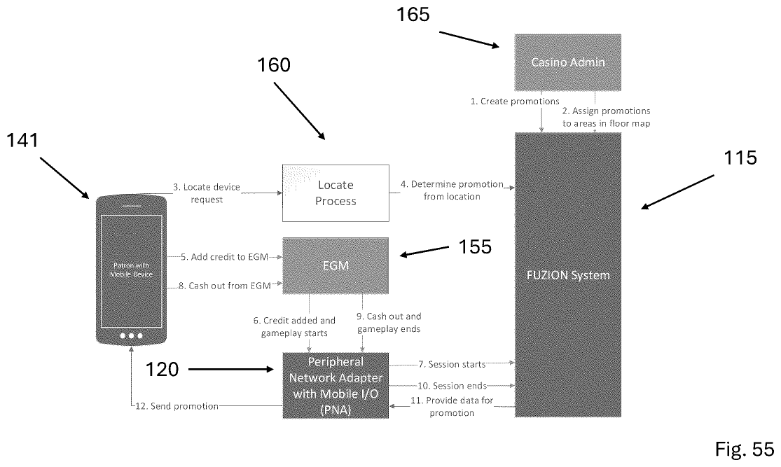

FIG. 55 illustrates a block diagram of a second arrangement of components whereby the system may send promotions to a patron based on EGM play according to the embodiments of the present invention. In this embodiment, casino personnel (e.g., marketing department) or casino administrator 165 create a promotion on the peripheral system 115. The promotion is assigned to a promotion zone on the casino floor map by the peripheral system 115. A patron with a mobile device 141 is detected nearby a BLE enabled device on an EGM 155 in the promotion zone and requests to be located. The Locate Process 160 determines the patron's mobile device's 141 location proximity to the EGM 155 which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started. Once the patron has completed their EGM gameplay session, the patron cashes out from the EGM 155. The PNA 120 is notified that the cash out occurred at the EGM 155 and the EGM gameplay session has ended. The PNA 120 sends a notification to the peripheral system 115 that the ongoing EGM gameplay session has ended. The peripheral system 115 sends content for the promotion to the PNA 120 of the EGM 155 in the promotion zone based on the completion of EGM gameplay. The PNA with the Mobile I/O sends the promotion to the patron's mobile device 141.

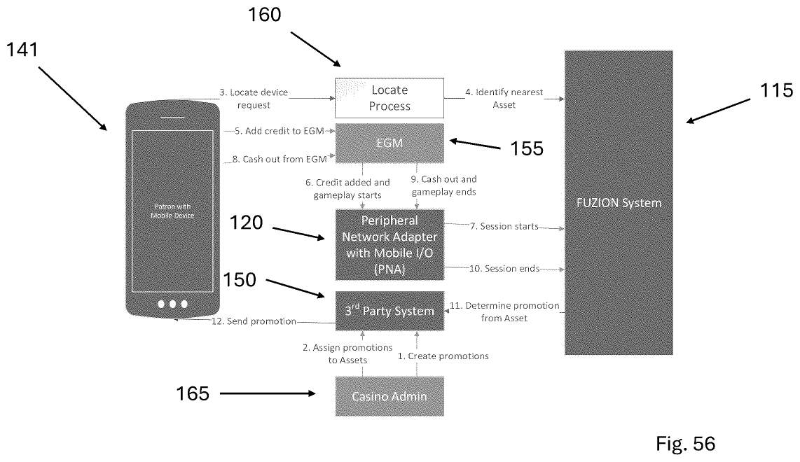

FIG. 56 is a block diagram of a third arrangement of components whereby the system may send promotions to a patron based on EGM play according to the embodiments of the present invention. In this embodiment, casino personnel (e.g., marketing department) or casino administrator 165 create a promotion on a 3^{rd} party system 150 and send the promotion to the peripheral system 115. The promotion is assigned to a promotion zone on the casino floor within the 3^{rd} party system 150. A patron with a mobile device 141 is detected nearby another BLE enabled device in the promotion zone and requests to be located. The Locate Process 160 determines the patron's location, via the patron's mobile device 141, on the casino floor map which can be calculated by either the peripheral system 115 or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started. Once the patron has completed their EGM gameplay session, the patron cashes out from the EGM 155. The PNA 120 is notified that the cash out occurred at the EGM 155 and the EGM gameplay session has ended. The PNA 120 sends a notification to the peripheral system 115 that the ongoing EGM gameplay session has ended. The peripheral system 115 sends content for the promotion to a 3^{rd} party system 150 of the EGM 155 to which the patron's mobile device 141 is most proximate. The 3^{rd} party system 150 sends the promotion to the patron's mobile device 141 based on completion of EGM gameplay (i.e., cashout).

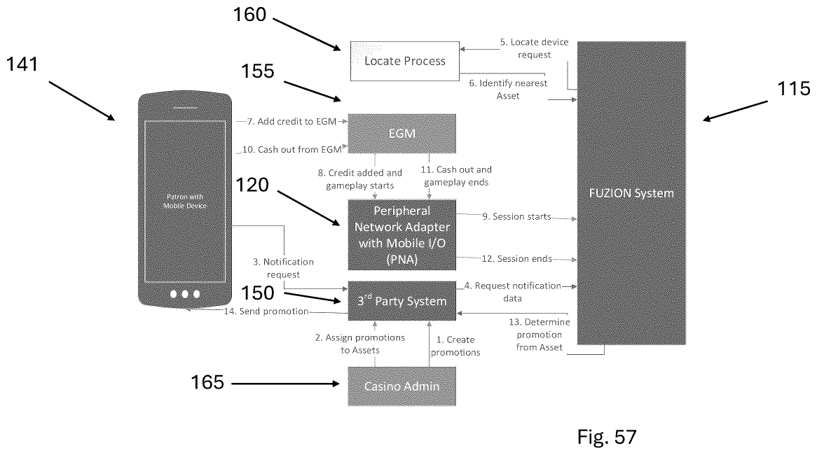

FIG. 57 is a block diagram of a fourth arrangement of components whereby the system may send promotions to a patron based on EGM play according to the embodiments of the present invention. In this embodiment, casino personnel (e.g., marketing department) or casino administrator 165 create a promotion on a 3^{rd} party system 150 and send the promotion to the peripheral system 115. The promotion is assigned to a promotion zone on the casino floor within the 3^{rd} party system 150. A patron with a mobile device 141 is detected nearby another BLE enabled device in the promotion zone and requests to be located. The 3^{rd} party system 150 requests that the patron's mobile device 141 be located. The peripheral system 115 provides data for the Locate Process 160 to identify where the patron's mobile device 141 is located which can be calculated by either the peripheral system 115, PNA 120, or a mobile application. The Locate Process 160 returns the patron's mobile device's 141 location on the casino floor map to the peripheral system 115. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started. Once the patron has completed their EGM gameplay session, the patron cashes out from the EGM 155. The PNA 120 is notified that the cash out occurred at the EGM 155 and the EGM gameplay session has ended. The PNA 120 sends a notification to the peripheral system 115 that the ongoing EGM gameplay session has ended. The peripheral system 115 notifies the 3^{rd} party system 150 of the EGM 155 the patron is most proximate and the patron's recently completed gameplay session. As the patron is in a promotion zone, the 3^{rd} party system 150 sends the promotion to the patron's mobile device 141 based on completion of gameplay (i.e., cashout).

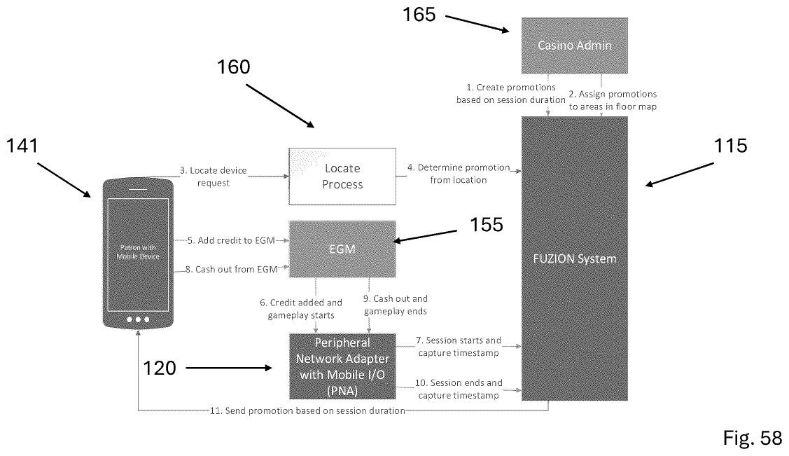

FIG. 58 is a block diagram of a first arrangement of components whereby the system may send promotions to a patron during EGM play according to the embodiments of the present invention. In this embodiment, casino personnel (e.g., marketing department) or casino administrator 165 create a promotion on the peripheral system 115. The promotion is assigned to a promotion zone on the casino floor map by the peripheral system 115. A patron with a mobile device 141 is detected nearby a BLE enabled device on an EGM 155 in the promotion zone and requests to be located. The Locate Process 160 determines the patron's location, via the patron's mobile device 141, on the casino floor map which can be calculated by either the peripheral system 115, PNA 120 or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started, and a timestamp is recorded to track the start of the gameplay session. Once the patron has completed their EGM gameplay session, the patron cashes out from the EGM 155. The PNA 120 is notified that the cash out occurred at the EGM 155 and the EGM gameplay session has ended. The PNA 120 sends a notification to the peripheral system 115 that the ongoing EGM gameplay session has ended, and a timestamp is recorded to track the start of the gameplay session. The peripheral system 115 sends the promotion to the patron's mobile device 141 based on the patron's mobile device 141 being in the promotion zone and meeting pre-established duration requirements of the EGM gameplay session.

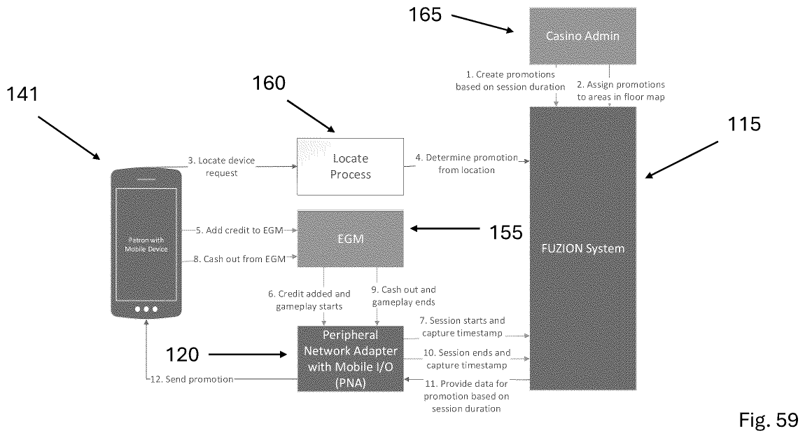

FIG. 59 is a block diagram of a second arrangement of components whereby the system may send promotions to a patron during EGM play according to the embodiments of the present invention. In this embodiment, casino personnel (e.g., marketing department) or casino administrator 165 create a promotion on the peripheral system 115. The promotion is assigned to a promotion zone on the casino floor map by the peripheral system 115. A patron with a mobile device 141 is detected nearby a BLE enabled device on an EGM 155 in the promotion zone and requests to be located. The Locate Process 160 determines the patron's mobile device's 141 location on the casino floor map which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started, and a timestamp is recorded to track the start of the gameplay session. Once the patron has completed their EGM gameplay session, the player will cash out from the EGM 155. The PNA 120 is notified that cash out occurred at the EGM 155 and the EGM gameplay session has ended. The PNA 120 sends a notification to the peripheral system 115 that the ongoing EGM gameplay session has ended, and a timestamp is recorded to track the end of the gameplay session. The peripheral system 115 sends content for the promotion to the PNA 120 of the EGM 155 in the promotion zone due to the gameplay session meeting the pre-established promotion's duration requirements. The PNA 120 with the Mobile I/O sends the promotion to the patron's mobile device 141.

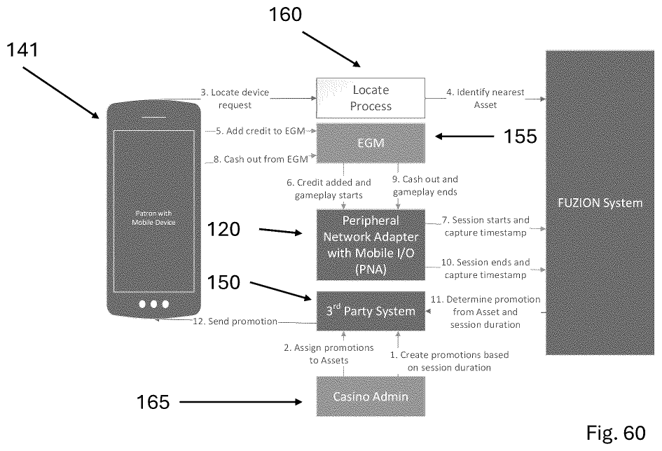

FIG. 60 is a block diagram of a third arrangement of components whereby the system may send promotions to a patron during EGM play according to the embodiments of the present invention. In this embodiment, casino personnel (e.g., marketing department) or casino administrator 165 create a promotion on the peripheral system 115. The promotion is assigned to a promotion zone on the casino floor map by the peripheral system 115. A patron with a mobile device 141 is detected nearby a BLE enabled device on an EGM 155 in the promotion zone and requests to be located. The Locate Process 160 determines the patron's mobile device's 141 location on the casino floor map which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started, and a timestamp is recorded to track the start of the gameplay session. Once the patron has completed their EGM gameplay session, the player will cash out from the EGM 155. The PNA 120 is notified that cash out occurred at the EGM 155 and the EGM gameplay session has ended. The PNA 120 sends a notification to the peripheral system 115 that the ongoing EGM gameplay session has ended, and a timestamp is recorded to track the end of the gameplay session. The peripheral system 115 notifies the 3^{rd} party system 150 of the EGM 155 the patron's mobile device 141 is most proximate and the length of the gameplay session. The 3^{rd} party system 150 sends the promotion to the patron's mobile device 141 based on meeting the duration requirements of the EGM gameplay session.

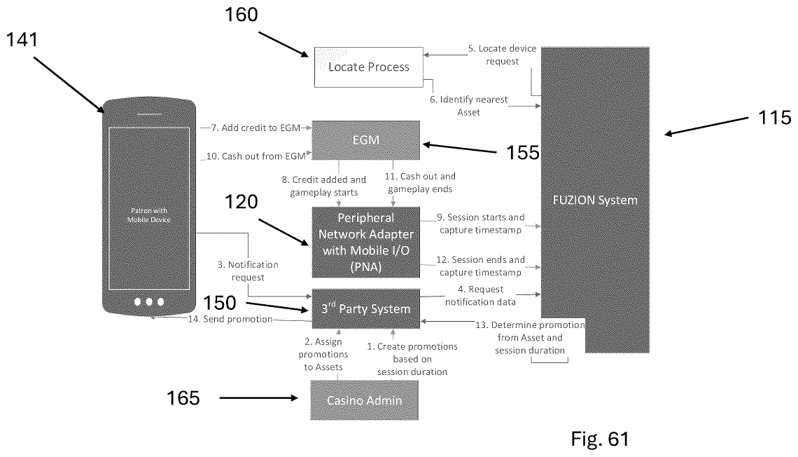

FIG. 61 is a block diagram of a fourth arrangement of components whereby the system may send promotions to a patron during EGM play according to the embodiments of the present invention. In this embodiment, casino personnel (e.g., marketing department) or casino administrator 165 create a promotion on a 3^{rd} party system 150 and send the promotion to the peripheral system 115. The promotion is assigned to a promotion zone on the casino floor within the 3^{rd} party system 150. A patron with a mobile device 141 is detected nearby another BLE enabled device in the promotion zone and requests to be located. The 3^{rd} party system 150 requests that the patron's mobile device 141 be located. The peripheral system 115 provides data for the Locate Process 160 to identify where the patron's mobile device 141 is located which can be calculated by either the peripheral system 115, PNA 120, or a mobile application. The Locate Process 160 returns the patron's mobile device's 141 location on the casino floor map to the peripheral system 115. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started, and a timestamp is recorded to track the start of the gameplay session. Once the patron has completed their EGM gameplay session, the patron cashes out from the EGM 155. The PNA 120 is notified that the cash out occurred at the EGM 155 and the EGM gameplay session has ended. The PNA 120 sends a notification to the peripheral system 115 that the ongoing EGM gameplay session has ended, and a timestamp is recorded to track the start of the gameplay session. The peripheral system 115 notifies the 3^{rd} party system 150 of the EGM 155 the patron is most proximate and the patron's recently completed gameplay session. As the patron is in a promotion zone, the 3^{rd} party system 150 sends the promotion to the patron's mobile device 141 based on duration requirements of the EGM gameplay session.

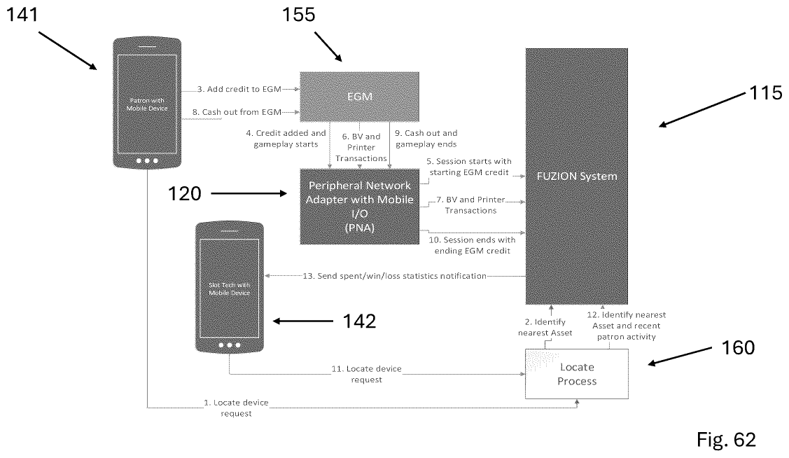

FIG. 62 is a block diagram of a first arrangement of components whereby the system may send gameplay notifications to the casino according to the embodiments of the present invention. A patron with a mobile device 141 is detected nearby a BLE enabled device on an EGM 155 and requests to be located. The Locate Process 160 determines the patron's mobile device's location on the casino floor map which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that an EGM gameplay session has started with the initial EGM credit. The PNA 120 is notified of additional notes and tickets inserted into the EGM 155. The PNA 120 sends a notification to the peripheral system 115 that additional notes and tickets were inserted into the EGM 155. Once the patron has completed their EGM gameplay session, the patron cashes out from the EGM 155. The PNA 120 is notified that cash out occurred at the EGM 155 and the EGM gameplay session has ended. The PNA 120 sends a notification to the peripheral system 115 that the gameplay session has ended with the final EGM credit. A slot tech with a mobile device 142 is detected nearby the same BLE enabled device and requests to be located. The Locate Process 160 determines the slot tech's mobile device's 142 location on the casino floor map which can be calculated by either the peripheral system 115, PNA 120, or a mobile application. The peripheral system 115 sends a notification to the slot tech's mobile device 142 containing a summary of the patron's spend/win/loss at the EGM 155.

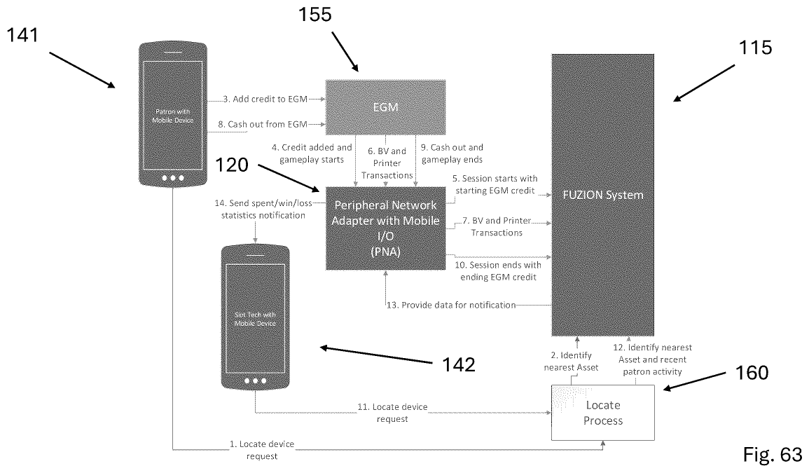

FIG. 63 illustrates a block diagram of a second arrangement of components whereby the system may send gameplay notifications to the casino according to the embodiments of the present invention. A patron with a mobile device 141 is detected nearby a BLE enabled device on an EGM 155 and requests to be located. The Locate Process 160 determines the patron's mobile device's 141 location on the casino floor map which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that a gameplay session has started with the initial EGM credit. The PNA 120 is notified of additional notes and tickets inserted into the EGM 155. The PNA 120 sends a notification to the peripheral system 115 that additional notes and tickets were inserted into the EGM 155. Once the patron has completed their EGM gameplay session, the patron cashes out from the EGM 155. The PNA 120 is notified that a cash out occurred at the EGM 155 and the EGM gameplay session has ended. The PNA 120 sends a notification to the peripheral system 115 that the gameplay session has ended with the final EGM credit. A slot tech with a mobile device 142 is detected nearby the same BLE enabled device and requests to be located. The Locate Process 160 determines the slot tech's mobile device's 142 location on the casino floor map which can be calculated by either the peripheral system 115, PNA 120, or the mobile application. The peripheral system 115 sends the PNA 120 a summary of the patron's spend/win/loss at the EGM 155. The slot tech's mobile device 142 receives a notification from the PNA 120 with the Mobile I/O with a summary of the patron's activity at the EGM 155.

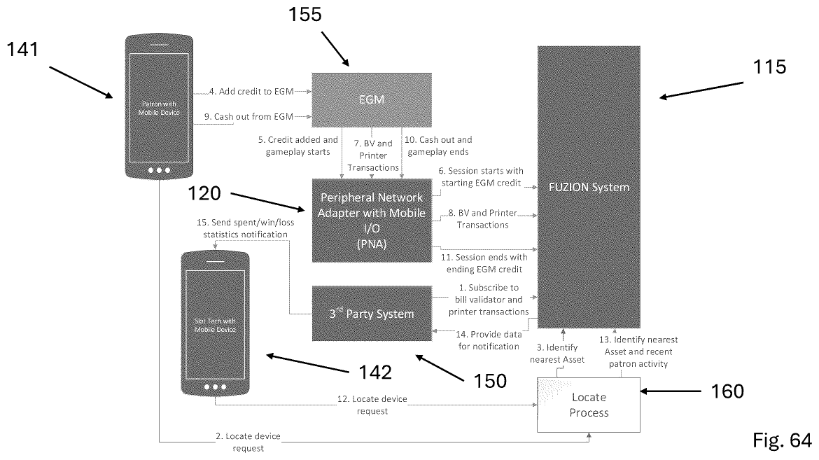

FIG. 64 is a block diagram of a third arrangement of components whereby the system may send gameplay notifications to the casino according to the embodiments of the present invention. A 3^{rd} party system 150 subscribes to receiving bill validator and printer transactions from the peripheral system 115. A patron with a mobile device 141 is detected nearby a BLE enabled device on an EGM 155 and requests to be located. The Locate Process 160 determines the patron's mobile device's 141 location on the casino floor map which can be calculated by either the peripheral system 115, PNA 120, or a mobile application. The patron adds credit to the EGM 155 by inserting a note or ticket. The PNA 120 is notified that credit was added to the EGM 155 and an EGM gameplay session has started. The PNA 120 sends a notification to the peripheral system 115 that a gameplay session has started with the initial EGM credit. The PNA 120 is notified of additional notes and tickets inserted into the EGM 155. The PNA 120 sends a notification to the peripheral system 115 that additional notes and tickets were inserted into the EGM 155. Once the patron has completed their EGM gameplay session, the patron cashes out from the EGM 155. The PNA 120 is notified that a cash out occurred at the EGM 155 and the EGM gameplay session has ended. The PNA 120 sends a notification to the peripheral system 115 that the gameplay session has ended with the final EGM credit. A slot tech with a mobile device 142 is detected nearby the same BLE enabled device and requests to be located. The Locate Process 160 determines the slot tech's mobile device's 142 location on the casino floor map which can be calculated by either the peripheral system 115, PNA 120, or the mobile application. The peripheral system 115 sends the 3^{rd} party system 150 a summary of the patron's spend/win/loss at the EGM 155. The slot tech's mobile device 142 receives a notification from the 3^{rd} party system 150 with a summary of the patron's activity at the EGM 155.

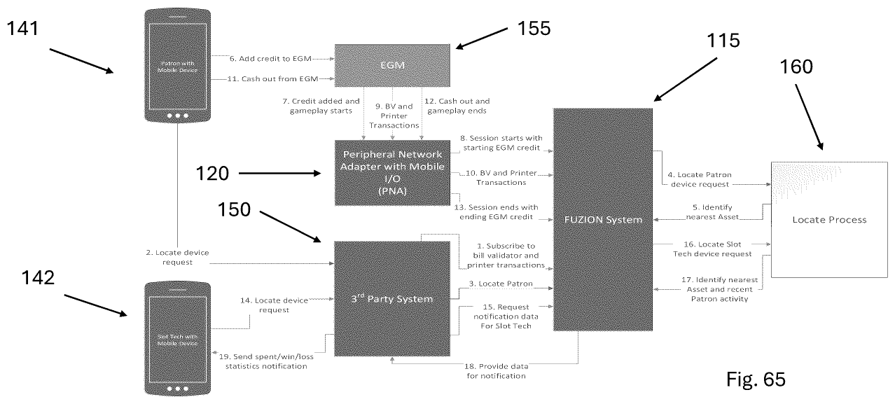

FIG. 65 is a block diagram of a fourth arrangement of components whereby the system may send gameplay notifications to the casino according to the embodiments of the present invention. A 3^{rd} party system 150 subscribes to receiving bill validator and printer transactions from the peripheral system 115. A patron with a mobile device 141 is detected nearby a BLE enabled device on an EGM 155 and requests to be located. The 3^{rd} party system 150 requests for the patron's mobile devices 141 to be located. The peripheral system 115 provides data for the Locate Process 160 to determine the location of the patron's mobile device 141 on the casino floor map which can be calculated by either the peripheral system 115, PNA 120, or a mobile application. The Locate Process 160 returns the location of the patron's mobile device 141 on the casino floor map to the peripheral system 115 allowing the peripheral system 115 to identify the EGM 155 where the patron is located. The patron adds credit to the EGM 155 by inserting a note or ticket. The PNA 120 is notified that credit was added to the EGM 155 and an EGM gameplay session has started. The PNA 120 sends a notification to the peripheral system 115 that a gameplay session has started with the initial EGM credit. The PNA 120 is notified of additional notes and tickets inserted into the EGM 155. The PNA 120 sends a notification to the peripheral system 115 that additional notes and tickets were inserted into the EGM 155. Once the patron has completed their EGM gameplay session, the patron cashes out from the EGM 155. The PNA 120 is notified that a cash out occurred at the EGM 155 and the EGM gameplay session has ended. The PNA 120 sends a notification to the peripheral system 115 that the gameplay session has ended with the final EGM credit. A slot tech with a mobile device 142 is detected nearby the same BLE enabled device and requests to be located. The 3^{rd} party system 150 requests for the slot tech's mobile device 142 to be located. The peripheral system 115 provides data for the Locate Process 160 to identify the location of the slot tech's mobile device 142 which can be calculated by either the peripheral system 115, PNA 120, or the mobile application. The Locate Process 160 returns the location of the slot tech's mobile device 142 on the casino floor map to the peripheral system 115, and the peripheral system 115 finds that the slot tech's mobile device 142 is near the same EGM 155 at which the patron was previously located. The peripheral system 115 sends the 3^{rd} party system 150 a summary of patron's spend/win/loss at the EGM 155. The slot tech's mobile device 142 receives a notification from the 3^{rd} party system 150 with a summary of the patron's activity at the EGM 155.

### EGM Usage

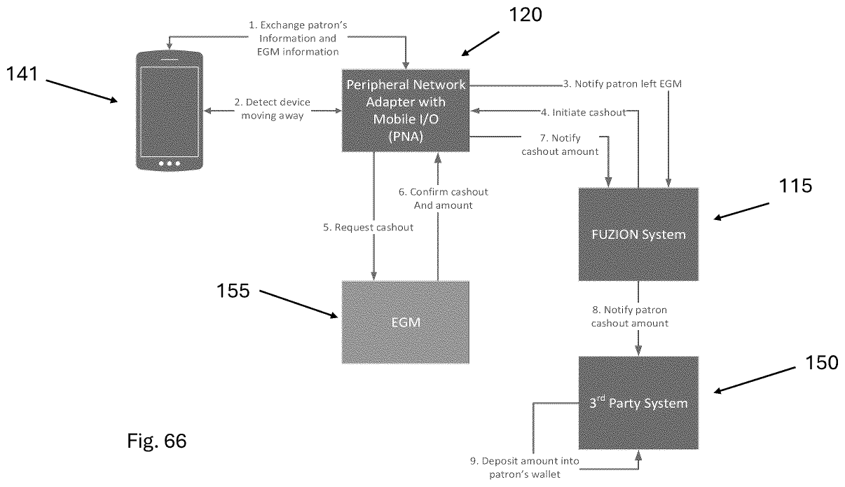

FIG. 66 is a block diagram of a first arrangement of components whereby the system may automate EGM actions according to the embodiments of the present invention. Initial information is exchanged between the PNA 120 and the patron's mobile device 141. The initial information identifies the patron on the 3^{rd} party system 150. The PNA 120 detects the patron's mobile device 141 moving away from the EGM 155. The PNA 120 then notifies the peripheral system 115. The peripheral system 115 initiates a cashout to the PNA 120. The PNA 120 requests a cashout by the EGM 155. The EGM 155 confirms the cashout and the amount with the PNA 120. The PNA 120 sends the cashout information back to the peripheral system 115. The peripheral system 115 notifies the 3^{rd} party system 150 with the patron information and cashout amount. The 3^{rd} party system 150 deposits the amount into the patron's digital wallet.

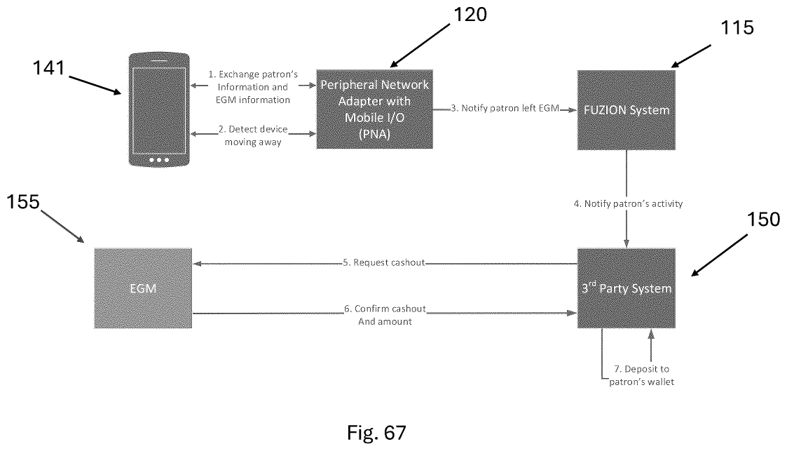

FIG. 67 is a block diagram of a second arrangement of components whereby the system may automate EGM actions according to the embodiments of the present invention. Initial information is exchanged between the PNA 120 and the patron's mobile device 141. The initial information identifies the patron on the 3^{rd} party system 150. The PNA 120 detects the patron's mobile device 141 moving away from the EGM 155. The PNA 120 then notifies the peripheral system 115. The peripheral system 115 notifies the 3^{rd} party system 150 regarding the patron's activity and confirms patron's identity and EGM ID therewith. The 3^{rd} party system 150 requests a cashout by the EGM 155. The EGM 155 confirms the cashout and the amount with the 3^{rd} party system 150. The 3^{rd} party system 150 deposits the amount into the patron's digital wallet.

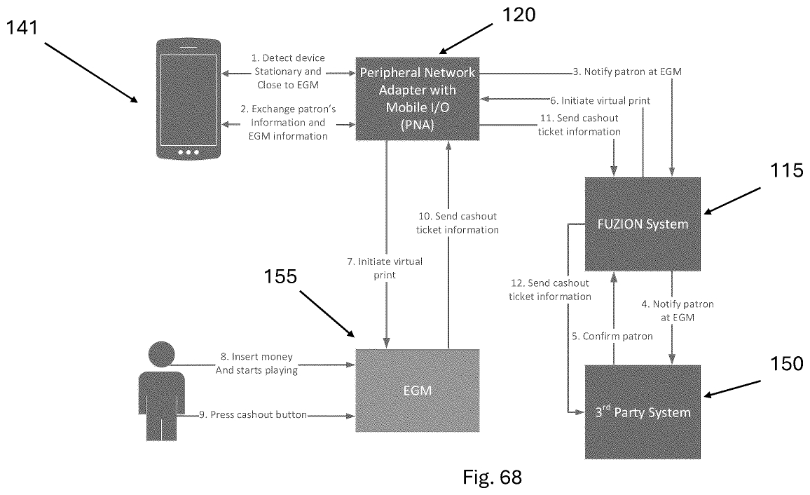

FIG. 68 is a block diagram of a third arrangement of components whereby the system may automate EGM actions according to the embodiments of the present invention. System detects patron's mobile device 141 stationary and proximate to an EGM 155. Initial information is exchanged between the PNA 120 and patron's mobile device 141. The information identifies the patron on the 3^{rd} party system 150. The PNA 120 transmits the patron's data and EGM 155 location to the peripheral system 115. The peripheral system 115 notifies the 3^{rd} party system 150 of the patron's information. The 3^{rd} party system 150 confirms the patron with the peripheral system 115. The peripheral system 115 initiates virtual print with the PNA 120. The PNA 120 sets printer to virtual print mode. Simultaneously, the patron can insert money and start playing. Once the patron finishes playing, the patron presses the cashout button on the EGM 155. Being in virtual mode, the printer does not print a physical ticket but instead sends the ticket information to the PNA 120. The PNA 120 transmits the ticket information to peripheral system 115. The peripheral system 115 passes the ticket information to the 3^{rd} party system 150 to deposit into the patron's digital wallet.

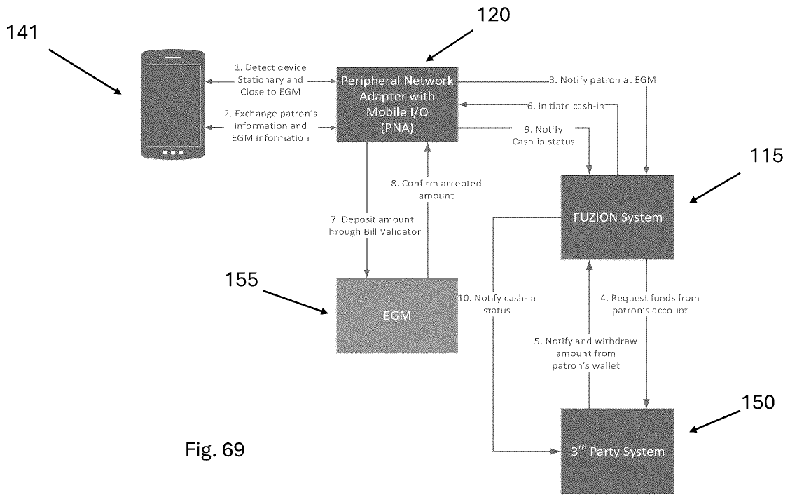

FIG. 69 is a block diagram of a fourth arrangement of components whereby the system may automate EGM actions according to the embodiments of the present invention. The PNA 120 detects the patron's mobile device 141 is stationary and proximate to an EGM 155. The PNA 120 exchanges patron's information through patron's mobile device 141. The PNA 120 notifies the peripheral system 115 that the patron is at EGM 155. The peripheral system 115 notifies and requests funds from the patron's digital account or wallet. The 3^{rd} party system 150 confirms and processes the patron's funds and instructs the peripheral system 115 to deposit funds into the EGM 155. The peripheral system 115 initiates the cash-in process through the PNA 120. The PNA 120 deposits the amount to the EGM 155 virtually through the EGM's bill validator. The EGM 155 confirms to the PNA 120 the amount accepted/rejected through the EGM's bill validator. The PNA 120 notifies cash-in status to the peripheral system 115. The peripheral system 115 notifies cash-in status to 3^{rd} party system 150.

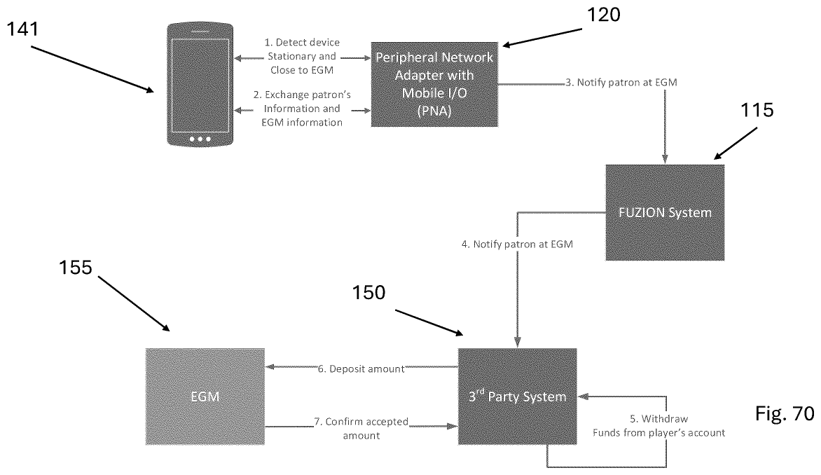

FIG. 70 is a block diagram of a fifth arrangement of components whereby the system may automate EGM actions according to the embodiments of the present invention. The PNA 120 detects the patron's mobile device 141 is stationary and proximate to an EGM 155. The PNA 120 exchanges patron's information through patron's mobile device 141. The PNA 120 notifies the peripheral system 115 that the patron is at EGM 155. The peripheral system 115 notifies the 3^{rd} party system 150 of the patron's and EGM's information. The 3^{rd} party system 150 confirms and processes patron's funds. The 3^{rd} party system 150 deposits amounts directly to the EGM 155. The EGM 155 confirms deposit status with the 3^{rd} party system 150.

### Casino Floor Usage

In this embodiment, the system is used to generate an accurate floor map of the assets (e.g., EGMs, kiosks, etc.) on the casino floor. The casino floor map is then used by the peripheral system for using a visual representation of the casino floor map for navigation, heatmapping and other purposes. In this embodiment, each asset on the casino floor is equipped with a peripheral network adapter with Mobile I/O (PNA). The Mobile I/O on each PNA has BLE capability to collect distance information to another BLE broadcasting device in proximity such as beacons, mobile devices, and/or another PNAs. In addition to distance information, BLE can be used to exchange information. The peripheral system works with the PNA in different ways to collect distance data from each PNA relative to another PNAs or fixed location beacons. Once data are collected, the peripheral system is able to generate an approximation of the casino floor map.

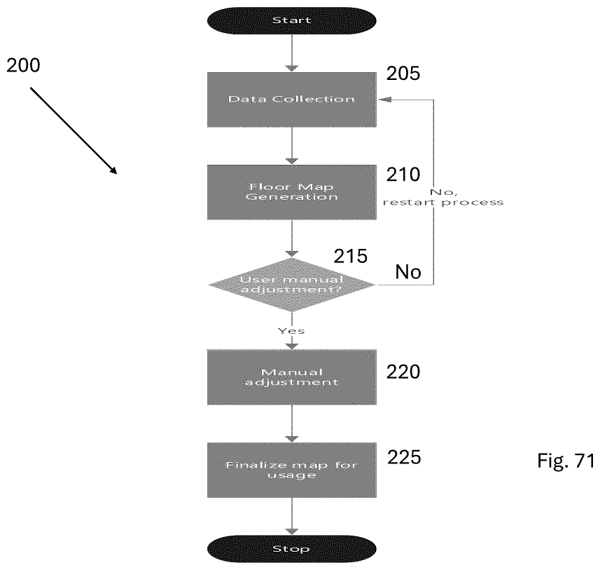

Users can manually adjust and finalize the casino floor map to ensure that the casino floor map is as accurate as possible for the peripheral system. The process involves several phases for the peripheral system to generate the casino floor map. The general workflow is detailed in the flow chart 200 shown in FIG. 71 detailing an asset mapping according to the embodiments of the present invention. The flow chart 200 comprises data collection 205, casino floor map generation 210, determination of user manual adjustment 215, user manual adjustment 220 and finalizing casino floor map 225. The steps remain essentially the same for the various embodiments detailed below except for the data collection step 205.

During the data collection phase 205, BLE distance data are collected by the peripheral system 115. The BLE distance data contains either PNA distance to nearby assets, fixed location BLE beacons, or both. The peripheral system 115 receives distance data from each PNA to approximate the location of the assets to generate the floor map.

Data collection may be accomplished using various hardware and software components. In a first embodiment, the PNAs associated with the peripheral system report distance data during the data collection phase. In this embodiment, the indoor location tracking features detailed above are utilized during the data collection phase. For example, in this embodiment, distances between BLE tags and PNAs, PNAs and BLE beacons and PNAs to PNAs may be used. The peripheral system 115 requests that the PNA 120 collects a list of distance data to nearby devices. The proximity data reported by the PNA 120 may include a list of distance data of any combination above depending on the nearby devices available.

In another embodiment, the data collection is accomplished using mobile devices. In this embodiment, the casino technician uses his/her mobile device 142 to collect distance data to assets for the peripheral system 115 during the data collection phase. In this embodiment, the indoor location tracking features detailed above are utilized during the data collection phase. For example, in this embodiment, distances between PNA 120 and mobile device, mobile device to BLE beacon and mobile device to PNA 120 may be used. In this embodiment, the casino technician move across the casino floor with the mobile device during the data collection phase. Both the mobile device and PNAs 120 report distance locations to the peripheral system. The peripheral system 115 uses the data reported by the mobile device, PNAs 120 or both to approximate location of the assets.

With the data collected, the casino floor map is generated 210. The peripheral system prompts the user to confirm or manually adjust the generated floor map 215.

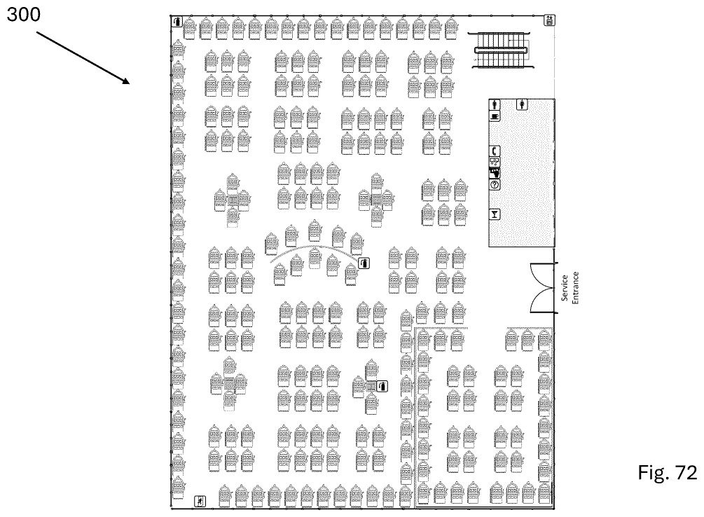

FIG. 72 is an exemplary casino floor map 300 generated according to the embodiments of the present invention. In one embodiment, the peripheral system anticipates that the assets shall relocate on a regular basis. Thus, the peripheral system uses the data from each PNA to confirm each PNA's surrounding assets and/or BLE beacons to confirm each PNA's last recorded location. When a PNA location change is detected, the peripheral system updates the internal mapping data automatically. The peripheral system may notify specific personnel of the casino floor map change as they occur. The peripheral system may also notify a technician when there are abnormalities discovered such as an invalid asset number by comparing the surrounding asset numbers.

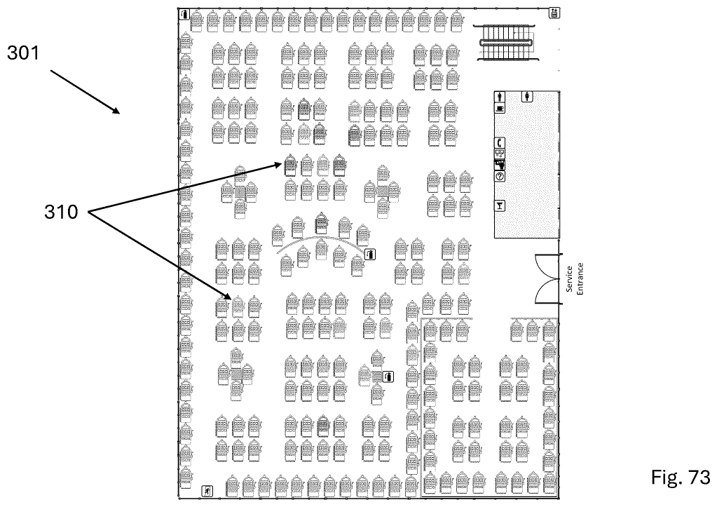

FIG. 73 is an exemplary casino floor map 301 generated with data feedback according to the embodiments of the present invention. As shown, in this embodiment, the peripheral system is configured to highlight assets 310 on the casino floor map based on various metrics filtered by the user such as: gameplay counts, wager amounts, occupancy time, etc. Highlighting the assets may involve using different colors, font, solid lines versus dotted lines, etc.

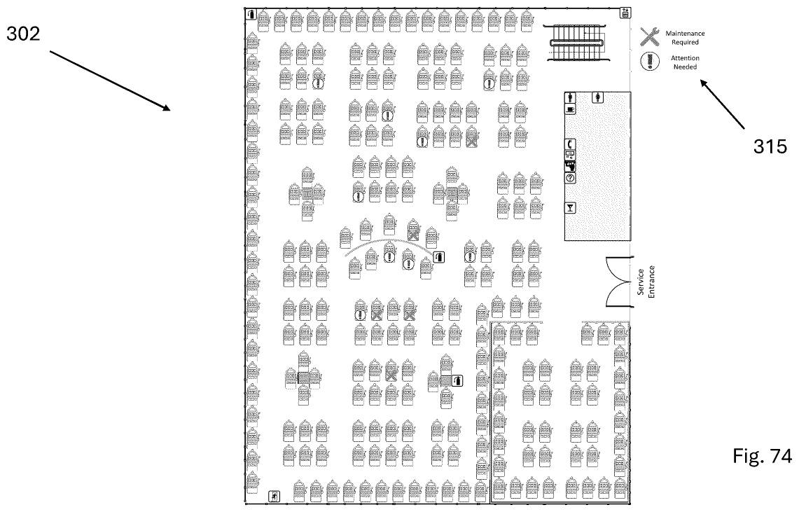

FIG. 74 is another exemplary casino floor map 302 generated with data feedback according to the embodiments of the present invention. As shown, the peripheral system may create alerts based on user set parameters. With the casino floor map, the peripheral system may visually highlight the assets for those alerts to assist in user planning. As shown, the peripheral system may highlight devices needing maintenance or other attention using various symbols.

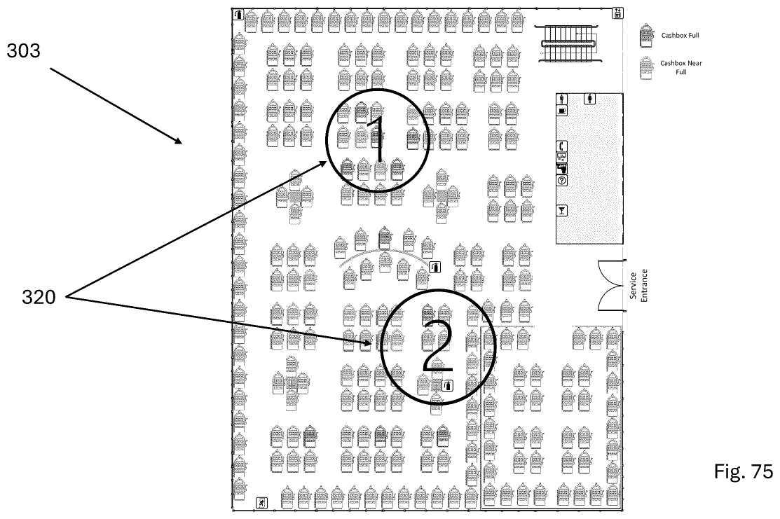

FIG. 75 is another exemplary casino floor map 303 generated with data feedback according to the embodiments of the present invention. As shown, the peripheral system 115 may create alerts based on cashbox levels. In this embodiment, the peripheral system 115 highlights groups of assets that require cashbox attention on the casino floor map. As shown, the peripheral system 115 may highlight zones 320 defining assets needing cashboxes attended to.

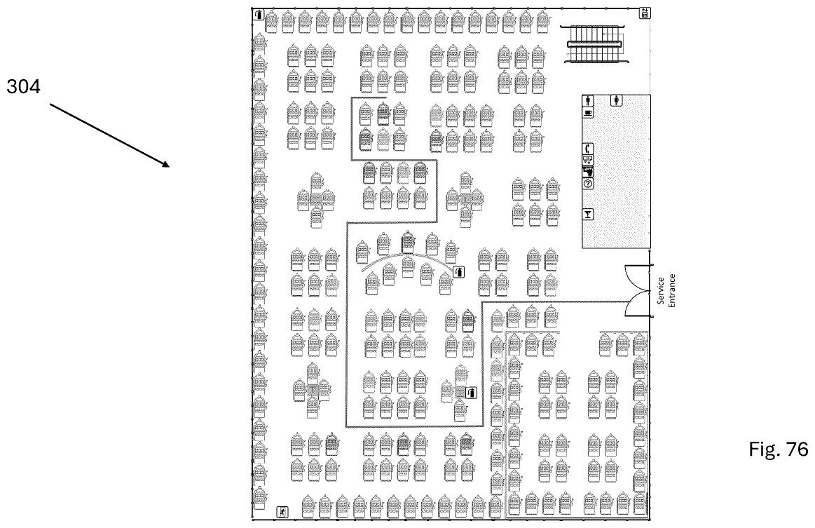

FIG. 76 is another exemplary casino floor map 304 generated with data feedback according to the embodiments of the present invention. As shown, using the casino floor map, the peripheral system may generate a route for the cashbox drop process to increase efficiency. During route generation, the system may take into consideration such options as the shortest route or in another embodiment, the system may take into account the occupancy data to create a route to avoid disruption to customers.

### Casino Operations

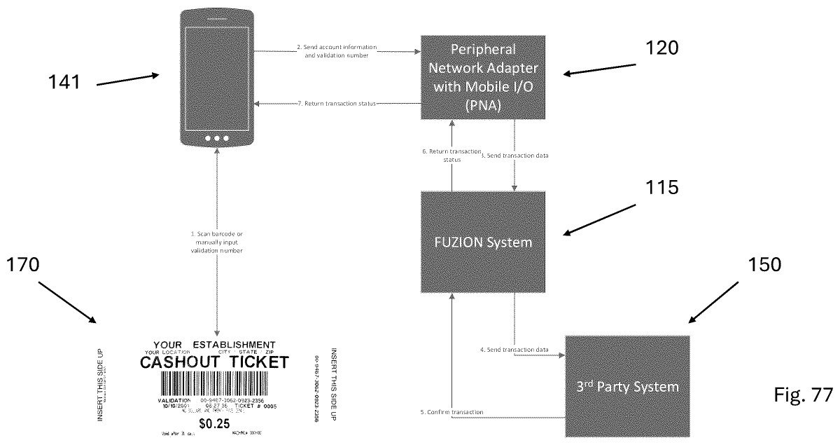

FIG. 77 is a block diagram of an arrangement of components whereby the system may facilitate a cash out to a player wallet according to the embodiments of the present invention. In this embodiment, the patron scans the barcode of a TITO ticket 170 or manually inputs validation number into a mobile application. The patron's mobile device 141 transfers account information and validation number to a PNA 120 using BLE. The PNA 120 sends the information to the peripheral system 115. The peripheral system 115 sends the information to the 3^{rd} party system 150 that interfaces with a casino TITO system. The 3^{rd} party system 150 returns the transaction status to the peripheral system 115. The peripheral system 115 returns the transaction status to the PNA 120. The PNA 120 updates the patron's mobile device 141 regarding the redemption result.

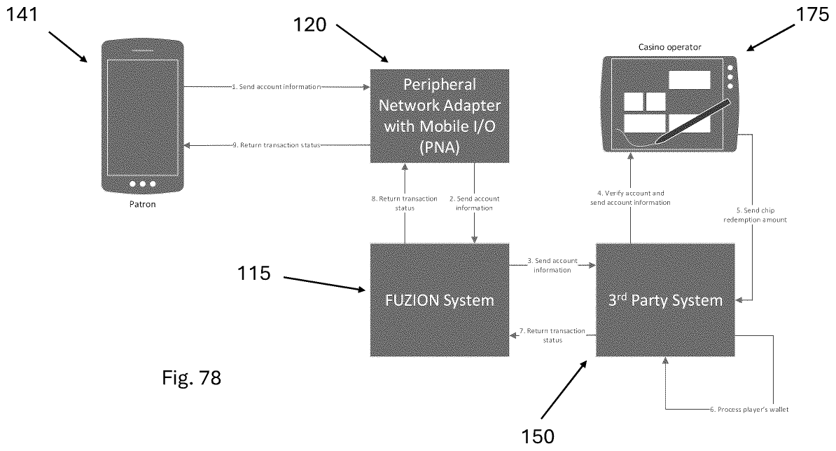

FIG. 78 is a block diagram of an arrangement of components whereby the system may redeem player chips to a player wallet according to the embodiments of the present invention. In this embodiment, the patron's mobile device 141 sends account information to the PNA 120. The PNA 120 sends the account information to the peripheral system 115. The peripheral system 115 sends the account information to the 3^{rd} party system 150. The 3^{rd} party system 150 sends the patron's account information to the casino operator equipment such as a tablet 175 according to the asset number of the PNA 120. The casino operator inputs the chip amount to redeem on the tablet 175. The 3^{rd} party system 150 processes the transaction. The 3^{rd} party system 150 then returns the transaction status to peripheral system 115. The peripheral system 115 returns the transaction status to the PNA 120. The PNA 120 updates the player's mobile device 141 with the transaction information.

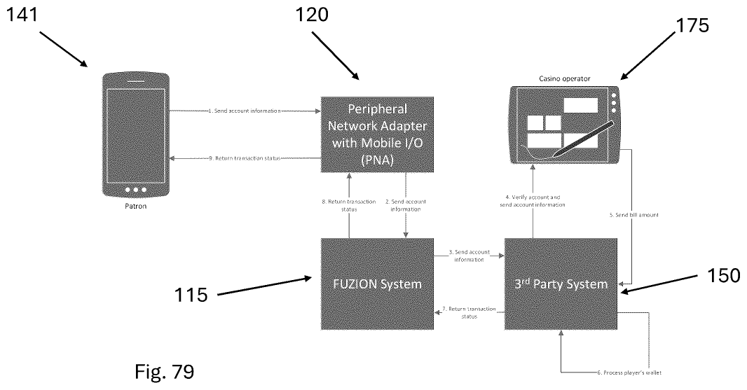

FIG. 79 is a block diagram of another arrangement of components whereby the system may pay a bill according to the embodiments of the present invention. In this embodiment, the patron's mobile device 141 sends account information to the PNA 120. The PNA 120 sends the account information to the peripheral system 115. The peripheral system 115 sends the patron's account information to the 3^{rd} party system 150. The 3^{rd} party system 150 sends the patron's account information to the casino operator equipment such as a tablet 175 according to the asset number of the PNA 120. The casino operator inputs the bill amount. The 3^{rd} party system 150 processes the transaction. The 3^{rd} party system 150 then returns the transaction status to peripheral system 115. The peripheral system 115 returns the transaction status to the PNA 120. The PNA 120 updates the player's mobile device 141 with the transaction information.

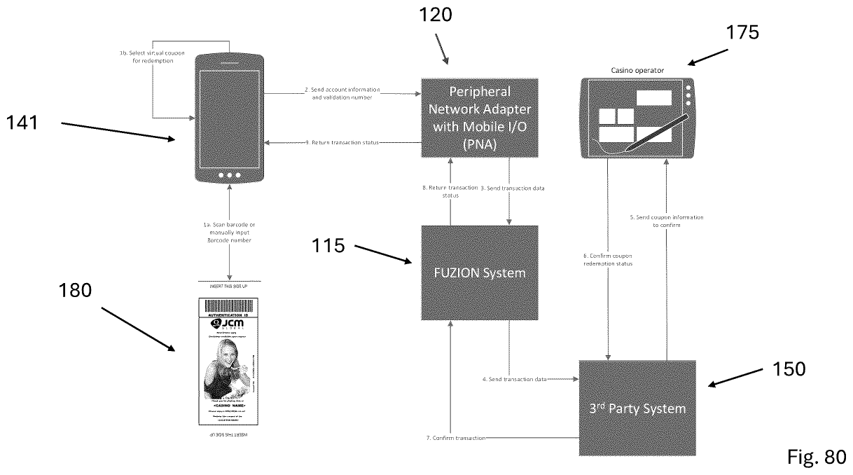

FIG. 80 is a block diagram of another arrangement of components whereby the system may redeem coupons according to the embodiments of the present invention. In this embodiment, the patron selects a coupon using their mobile device 141 by (i) inputting a physical coupon by scanning or manual inputting the barcode number or (ii) selecting a virtual coupon from their player application. The mobile device 141 sends the account information and coupon number to the PNA 120. The PNA 120 send the transaction data to the peripheral system 115. The peripheral system 115 sends the transaction data to the 3^{rd} party system 150. The 3^{rd} party system 150 sends the patron's account information and coupon redemption prompt to a tablet 175. The casino operator confirms the coupon and the tablet 175 updates the 3^{rd} party system 150. The 3^{rd} party system 150 confirms the transaction with the peripheral system 115. The peripheral system 115 returns the transaction status to the PNA 120. The PNA 120 returns the transaction status to the mobile device 141.

As detailed above, in one embodiment, each slot machine on a casino floor is equipped with a PNA with Mobile I/O device 120 to provide BLE micro-positioning features for the accompany peripheral system (e.g., the FUZION system of the applicant). The number EGMs near one another means that many PNAs will be broadcasting a BLE signal. The number of BLE signals can impact the quality of the connection between different devices. To reduce such interference, the Mobile I/O is designed to autotune the BLE signal strength being output by the device to reduce the distance the signal travels, improve distance measurements and reduce interference with neighboring assets. The autotune process involves collecting signal strength data from surrounding Mobile I/O devices and then calculating the appropriate signal strength based on the result. In one embodiment, the autotune workflow for the Mobile I/O device comprises. (i) the Mobile I/O searching for other assets in the area; (ii) for each asset discovered, the Mobile I/O records the signal strength; (iii) the Mobile I/O then calculates an appropriate signal strength value based on the list of the signal strength values from the previous step; and (iv) based on the strength, the Mobile I/O updates its own output signal strength.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, used specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

Although the invention has been described in detail with reference to several embodiments, additional variations and modifications exist within the scope and spirit of the invention as described and defined in the following claims.

1. A casino system comprising:
a peripheral system in communication with a casino network linking a plurality of electronic gaming machines in a casino environment;
a plurality of BLE beacons and/or BLE tags associated with said plurality of said electronic gaming machines, said plurality of BLE beacons and/or BLE tags configured to transmit wireless signals;
one or more autotune modules associated with one or more of said plurality of BLE beacons and/or BLE tags, said one or more autotune modules configured to measure wireless signal strength of proximate BLE beacons and/or BLE tags and, based on measured wireless signal strength of said proximate BLE beacons and/or BLE tags, calculate an appropriate wireless signal strength for a BLE beacon and/or BLE tag to which it is associated and update an output signal strength of said BLE beacon and/or BLE tags to which it is associated to said calculated appropriate wireless signal strength to reduce the distance the signal travels to minimize interference between said plurality of BLE beacons and/or BLE tags; and
one or more receivers in communication with said peripheral system, said one or more receivers configured to receive said wireless signals transmitted by said plurality of BLE beacons and/or BLE tags, said one or more receivers and/or peripheral system configured to approximate a physical distance between a BLE beacon and/or BLE tag sending a signal and said one or more receivers receiving the same.

2. The casino system of claim 1 wherein said one or more receivers are peripheral network adapters or mobile devices.

3. The casino system of claim 1 further comprising a plurality of peripheral network adapters in communication with said peripheral system and associated with one or more of said electronic gaming machines.

4. The casino system of claim 1 further comprising a stored casino floor map.

5. A casino system comprising:
a peripheral system in communication with a casino network linking a plurality of electronic gaming machines in a casino environment;
a plurality of peripheral network adapters associated with said plurality of said electronic gaming machines, said plurality of peripheral network adapters configured to transmit wireless signals;
one or more autotune modules associated with one or more of said plurality of peripheral network adapters, said one or more autotune modules configured to measure wireless signal strength of proximate peripheral network adapters and, based on measured wireless signal strength of said proximate peripheral network adapters, calculate an appropriate wireless signal strength for a peripheral network adapter to which it is associated and update its own output signal strength to said calculated appropriate wireless signal strength to reduce the distance the signal travels to minimize interference between said plurality of BLE beacons and/or BLE tags; and
one or more receivers in communication with said peripheral system, said one or more receivers configured to receive said wireless signals transmitted by said plurality of peripheral network adapters, said one or more receivers and peripheral system configured to approximate a physical distance between said peripheral network adapters and said one or more receivers.

6. The casino system of claim 5 wherein said receiver is a peripheral network adapter or mobile device.

7. The casino system of claim 5 further comprising a plurality of BLE beacons and/or BLE tags.

8. The casino system of claim 5 further comprising a stored casino floor map.

9-14. (canceled)
